(19) United States
(12) Patent Application Publication
(10) Pub. No.: US 2023/0305699 A1
(43) Pub. Date: Sep. 28, 2023

(54) METADATA HANDLING FOR TWO-TERMINAL MEMORY

(71) Applicant: Crossbar, Inc., Santa Clara, CA (US)

(72) Inventors: Ruchirkumar Shah, San Jose, CA (US); Mehdi Asnaashari, Danville, CA (US)

(21) Appl. No.: 17/696,481

(22) Filed: Mar. 16, 2022

(51) Int. Cl. G06F 3/06

(52) U.S. Cl. CPC G06F 3/0604; G06F 3/0644; G06F 3/0679

(57) ABSTRACT

One potential result of differing characteristics for certain two-terminal memory (TTM) is that memory management techniques, such as logical-to-physical (L2P), can differ as well. Previous memory management techniques do not adequately leverage the advantages associated with TTM. For example, by identifying and leveraging certain advantageous characteristics of TTM, L2P tables can be designed to be smaller and more efficient. Moreover, other memory management operations such as wear-leveling, recovery from power loss, and so forth, can be more efficient.

### INCORPORATION BY REFERENCE

The following are hereby incorporated by reference in their entireties and for all purposes. U.S. Pat. App. No. 14/588,185, filed Dec. 31, 2014, U.S. Pat. App. No. 11/875,541 filed Oct. 19, 2007, U.S. Pat. App. No. 12/575,921 filed Oct. 8, 2009, U.S. Pat. App. No. 14/636,363 filed Mar. 3, 2015, U.S. Pat. App. No. 15/426,298 filed Feb. 7, 2017, and U.S. Pat. App No. 15/428,721 filed Feb. 9, 2017.

### TECHNICAL FIELD

This disclosure generally relates to memory management techniques and more specifically to metadata handling for metadata used in connection with memory management of two-terminal memory.

### BACKGROUND

Two-terminal, resistive-switching memory represents a recent innovation within the field of integrated circuit technology. While much of resistive-switching memory technology is in the development stage, various technological concepts for resistive-switching memory have been demonstrated by the inventor(s) and are in one or more stages of verification to prove or disprove associated theories or techniques. The inventor(s) believe that resistive-switching memory technology shows compelling evidence to hold substantial advantages over competing technologies in the semiconductor electronics industry.

The inventor(s) believe that resistive-switching memory cells can be configured to have multiple states with distinct resistance values. For instance, for a single bit cell, the restive-switching memory cell can be configured to exist in a relatively low resistance state or, alternatively, in a relatively high resistance state. Multi-bit cells might have additional states with respective resistances that are distinct from one another and distinct from the relatively low resistance state and the relatively high resistance state. The distinct resistance states of the resistive-switching memory cell represent distinct logical information states, facilitating digital memory operations. Accordingly, the inventor(s) believe that arrays of many such memory cells, can provide many bits of digital memory storage.

The inventor(s) have been successful in inducing resistive-switching memory to enter one or another resistive state in response to an external condition. Thus, in transistor parlance, applying or removing the external condition can serve to program or de-program (e.g., erase) the memory. Moreover, depending on physical makeup and electrical arrangement, a resistive-switching memory cell can generally maintain a programmed or de-programmed state. Maintaining a state might require other conditions be met (e.g., existence of a minimum operating voltage, existence of a minimum operating temperature, and so forth), or no conditions be met, depending on the characteristics of a memory cell device.

The inventor(s) have put forth several proposals for practical utilization of resistive-switching technology to include transistor-based memory applications. For instance, resistive-switching elements are often theorized as viable alternatives, at least in part, to metal-oxide semiconductor (MOS) type memory transistors employed for electronic storage of digital information. Models of resistive-switching memory devices provide some potential technical advantages over non-volatile FLASH MOS type transistors.

In light of the above, the inventor(s) desire to continue developing practical utilization of resistive-switching technology.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its purpose is to present some concepts of the specification in a simplified form as a prelude to the more detailed description that is presented in this disclosure.

The subject disclosure provides for a memory device comprising a controller that manages metadata. The metadata can represent information used to facilitate memory management procedures such as, for example, L2P mapping procedures, wear leveling procedures and so forth. The memory device can further comprise a first memory that can be operatively coupled to the controller. The first memory can comprise an array of non-volatile two-terminal memory (TTM) cells. The first memory can comprise multiple partition.

For example, the first memory can comprise a data partition. The data partition can be representative of usable memory that is available to store host data provided by a host device. As another example, the first memory can comprise a metadata partition. The metadata partition can be representative of non-usable memory that is not available to store the host data provided by the host device. The metadata partition can store a first copy of the metadata and a second copy of the metadata.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout. In this specification, numerous specific details are set forth in order to provide a thorough understanding of this disclosure. It should be understood, however, that certain aspects of the subject disclosure may be practiced without these specific details, or with other methods, components, materials, etc. In other instances, well-known structures and devices are shown in block diagram form to facilitate describing the subject disclosure.

FIG. 1 illustrates a block diagram of a system that provides for a thin and efficient logical-to-physical (L2P) mapping in accordance with certain embodiments of this disclosure.

FIG. 2A illustrates an example block diagram illustrating various examples relating to logical and physical spaces in connection with L2P mapping in accordance with certain embodiments of this disclosure.

FIG. 2B illustrates an example block diagram illustrating example hierarchical views of a PG and a physical block in accordance with certain embodiments of this disclosure.

FIG. 3 depicts an example block diagram that illustrates various example striping profiles in accordance with certain embodiments of this disclosure.

FIG. 4 depicts an example system illustrating various examples relating to a configurable group size in connection with L2P translation in accordance with certain embodiments of this disclosure.

FIG. 5 illustrates an example memory device that provides for additional aspects or elements in connection with thin and efficient logical-to-physical (L2P) mapping in accordance with certain embodiments of this disclosure.

FIG. 6A illustrates an example block diagram that provides an example of write counter data in accordance with certain embodiments of this disclosure.

FIG. 6B illustrates an block diagram that provides an example of the static wear leveling (SWL) table in accordance with certain embodiments of this disclosure.

FIG. 7 illustrates an example block diagram that depicts an example swapping procedure that can be facilitated by a controller in connection with WL function in accordance with certain embodiments of this disclosure.

FIG. 8 illustrates a block diagram of an example system that can provide for metadata handling and other metadata management functionality in accordance with certain embodiments of this disclosure.

FIG. 9A depicts a block diagram of an example system illustrating a second memory that is coupled to the controller in accordance with certain embodiments of this disclosure.

FIG. 9B depicts a block diagram of an example system illustrating a second memory that is operatively coupled to a host device that is accessible to the controller via a host interface in accordance with certain embodiments of this disclosure.

FIG. 10 illustrates a block diagram of an example metadata update sequence in connection with a wear-leveling example in accordance with certain embodiments of this disclosure.

FIG. 11 illustrates an example methodology that can provide for an example procedure or method of managing metadata in accordance with certain embodiments of this disclosure.

FIG. 12 illustrates an example methodology that can provide for additional aspects or elements in connection with managing metadata in accordance with certain embodiments of this disclosure.

FIG. 13 illustrates an example methodology that can provide for an example procedure or method of loading the metadata to a second memory upon power on in accordance with certain embodiments of this disclosure.

FIG. 14 illustrates an example methodology can provide for additional aspects or elements in connection with loading the metadata to the second memory upon power on in accordance with certain embodiments of this disclosure.

FIG. 15 illustrates a block diagram of an example electronic operating environment in accordance with certain embodiments of this disclosure.

FIG. 16 illustrates a block diagram of an example computing environment in accordance with certain embodiments of this disclosure.

### DETAILED DESCRIPTION

### Introduction to Two-terminal Memory

This disclosure relates to two-terminal memory cells employed for digital or multi-level information storage. In some embodiments, the two-terminal memory cells can include a resistive technology, such as a resistive-switching two-terminal memory cell. Resistive-switching two-terminal memory cells (also referred to as resistive-switching memory cells or resistive-switching memory), as utilized herein, comprise circuit components having conductive contacts (e.g., electrodes or terminals) with an active region between the two conductive contacts. The active region of the two-terminal memory device, in the context of resistive-switching memory, exhibits a plurality of stable or semi-stable resistive states, each resistive state having a distinct electrical resistance. Moreover, respective ones of the plurality of states can be formed or activated in response to a suitable electrical signal applied at the two conductive contacts. The suitable electrical signal can be a voltage value, a current value, a voltage or current polarity, or the like, or a suitable combination thereof. Examples of a resistive switching two-terminal memory device, though not exhaustive, can include a resistive random access memory (RRAM), a phase change RAM (PCRAM) and a magnetic RAM (MRAM). In various embodiments, one or more additional layers (e.g., blocking layer(s), adhesion layer(s), tunneling layer(s), ohmic contact layer(s), etc., or a suitable combination thereof) can be provided as part of the resistive-switching two-terminal memory cells, whether between the two conductive contacts, external to the conductive contacts or a suitable combination thereof.

Embodiments of the subject disclosure can provide a filamentary-based memory cell. In some embodiments, the filamentary-based memory cell includes a non-volatile memory device, whereas other embodiments provide a volatile selector device in electrical series with the non-volatile memory device. In further embodiments, both the volatile selector device and the non-volatile memory device can be filamentary-based devices, though the subject disclosure is not limited to these embodiments.

One example of a filamentary-based device can comprise: one or more conductive layers (e.g., comprising, e.g., TiN, TaN, TiW, metal compounds), an optional interface layer (e.g., doped p-type (or n-type) silicon (Si) bearing layer (e.g., p-type or n-type polysilicon, p-type or n-type polycrystalline SiGe, etc., or a combination of the foregoing)), a resistive switching layer (RSL) and an active metal layer capable of being ionized. Under suitable conditions, the active metal layer can provide filament forming ions to the RSL. In such embodiments, a conductive filament (e.g., formed by the ions) can facilitate electrical conductivity through at least a subset of the RSL, and a resistance of the filament-based device can be determined by a tunneling resistance (or, e.g., ohmic contact resistance) between the filament and the conductive layer. To reverse electrical conductivity resulting from the conductive filament, whether for the volatile selector device or the non-volatile memory device (with the exception of one-time programmable memory devices), the filament can be deformed. In some embodiments, deformation of the filament can comprise the particles (e.g., metal ions) - trapped within the defect locations - becoming neutral particles (e.g., metal atoms) in absence of the bias condition that have a high electrical resistance. In other embodiments, deformation of the filament can comprise dispersion (or partial dispersion) of the particles within the RSL, breaking a conductive electrical path provided by the filament in response to the bias condition. In still other embodiments, deformation of the filament can be in response to another suitable physical mechanism, or a suitable combination of the foregoing.

Generally, deformation of a conductive filament results from a change in the bias conditions to a second set of bias conditions. The second set of bias conditions can vary for different devices. For instance, deformation of a conductive filament formed within the volatile selector device can be implemented by reducing an applied bias below a formation magnitude (or small range of magnitudes, such as a few tens of a volt) associated with filament formation within the volatile selector device. Depending on the embodiment, a conductive filament can be created within a volatile selector device in response to a positive bias (e.g., forward bias) or in response to a negative bias (e.g., reverse bias), and deformation of the filament can occur in response to a suitable lower-magnitude positive bias or a suitable lower-magnitude negative bias, respectively. See U.S. Pat. Application serial No. 14/588,185 filed Dec. 31, 2014 commonly owned by the assignee of the present application, and incorporated by reference herein in its entirety and for all purposes. In contrast, deformation of a conductive filament formed within the non-volatile memory device can be implemented by providing a suitable erase bias (e.g., a reverse bias), having opposite polarity from a program bias (e.g., forward bias) utilized to form the conductive filament within the non-volatile memory device.

In various embodiments of a memory cell of the present disclosure, a conductive layer may include a metal, a doped semiconductor, titanium, titanium nitride (TiN), tantalum nitride (TaN), tungsten (W) or other suitable electrical conductor. The RSL (which can also be referred to in the art as a resistive switching media (RSM)) can comprise, e.g., an undoped amorphous Si layer, a semiconductor layer having intrinsic characteristics, a silicon nitride (e.g. SiN, Si3N4, SiNx where x is a suitable positive number, etc.), a Si sub-oxide (e.g., SiO_{y} wherein y has a value between 0.1 and 2), a Si sub-nitride (e.g., SiNy wherein y has a value between 0.1 and 2), an Al sub-oxide, an Al sub-nitride, and so forth. Other examples of materials suitable for the RSL could include SiₓGe_{y}O_{z} (where X, Y and Z are respective suitable positive numbers), a silicon oxide (e.g., SiO_{N}, where N is a suitable positive number), a silicon oxynitride, an undoped amorphous Si (a-Si), amorphous SiGe (a-SiGe), TaO_{B} (where B is a suitable positive number), HfOc (where C is a suitable positive number), TiO_{D} (where D is a suitable number), Al₂O_{E} (where E is a suitable positive number) or other suitable oxides, a metal nitride (e.g., AlN, AlN_{F} where F is a suitable positive number), a non-stoichiometric silicon compound, and so forth, or a suitable combination thereof. In various embodiments, the RSL includes a number of material voids or defects to trap or hold particles in place, in the absence of an external program stimulus causing the particles to drift within the RSL and form the conductive filament. For the non-volatile memory device then, the particles can remain trapped in the absence of the external program stimulus, requiring a suitable reverse bias (e.g., a negative polarity erase stimulus) to drive the particles out of the voids/defects, or otherwise break continuity of the conductive filament, thereby deforming the conductive filament.

The contact material layer can be comprised of any suitable conductor, such as a conductive metal, a suitably doped semiconductor, or the like. Where utilized, the contact material layer can be employed to provide good ohmic contact between the RSL and a metal wiring layer of an associated memory architecture. In some embodiments, the contact material layer can be removed and the RSL can be in physical contact with a metal wiring layer. Suitable metal wiring layers can include copper, aluminum, tungsten, platinum, gold, silver, or other suitable metals, suitable metal alloys, or combinations of the foregoing. In further embodiments, a diffusion mitigation layer or adhesion layer can be provided between the RSL and the metal wiring layer (or between the RSL and the contact material layer).

Examples of the active metal layer can include, among others: silver (Ag), gold (Au), titanium (Ti), titanium nitride (TiN) or other suitable compounds of titanium, nickel (Ni), copper (Cu), aluminum (Al), chromium (Cr), tantalum(Ta), iron (Fe), manganese (Mn), tungsten (W), vanadium (V), cobalt (Co), platinum (Pt), and palladium (Pd), a suitable nitride of one or more of the foregoing, or a suitable oxide of one or more of the foregoing. Other suitable conductive materials, as well as compounds or combinations of the foregoing or similar materials can be employed for the active metal layer in some aspects of the subject disclosure. In some embodiments, a thin layer of barrier material composed of Ti, TiN, or the like, may be disposed between the RSL and the active metal layer (e.g., Ag, Al, and so on). Details pertaining to additional embodiments of the subject disclosure similar to the foregoing example(s) can be found in the following U.S. patent applications that are licensed to the assignee of the present application for patent: Application Serial Number 11/875,541 filed Oct. 19, 2007, Application Serial Number 12/575,921 filed Oct. 8, 2009, and the others cited herein, each of which are incorporated by reference herein in their respective entireties and for all purposes.

In response to a suitable program stimulus (or set of stimuli) a conductive path or a filament of varying width and length can be formed within a relatively high resistive portion of a non-volatile memory device (e.g., the RSL). This causes a memory cell associated with the non-volatile memory device to switch from a relatively high resistive state, to one or more relatively low resistive states. In some resistive-switching devices, an erase process can be implemented to deform the conductive filament, at least in part, causing the memory cell to return to the high resistive state from the low resistive state(s), as mentioned previously. This change of state, in the context of memory, can be associated with respective states of a binary bit or multiple binary bits. For an array of multiple memory cells, a word(s), byte(s), page(s), etc., of memory cells can be programmed or erased to represent zeroes or ones of binary information, and by retaining those states over time in effect storing the binary information. In various embodiments, multi-level information (e.g., multiple bits) may be stored in respective memory cells.

According to various disclosed embodiments, disclosed resistive switching devices can be fabricated consistent with foundry compatible processes. As utilized herein, foundry compatible refers to consistency with physical constraints associated with fabrication of a semiconductor-based device in a commercial semiconductor fabrication foundry, such as Taiwan Semiconductor Manufacturing Corporation, among others. Physical constraints include a thermal budget (e.g., maximum operating temperature) of a die, and of materials and metals constructed on the die prior to a given process step. For example, where a die comprises one or more metal layers or constructs, and viability of device models require the metal layers to maintain tight position tolerance, the thermal budget may be set by the softening temperature of the metal(s) to avoid loss of metal rigidity. Other physical constraints can include, CMOS, nMOS or pMOS fabrication constraints, where suitable, fabrication toolset limitations of a particular metallization scheme (e.g., etching/masking/grooving toolsets available for Aluminum, Copper, etc.), physical properties requiring special process handling (e.g., dispersion properties of Cu, oxidation properties of metals, semi-conducting materials, etc.), or the like, or other constraints of commercial foundry. Accordingly, the phrase “foundry compatible” implies consistency with process limitations of at least one commercial semiconductor fabrication foundry.

Thermal budget refers to an amount of thermal energy transferred to a wafer during a particular temperature operation. During the process of manufacturing the resistive memory, for example, there is a desire to not adversely affect complementary metal oxide semiconductor (CMOS) devices by application of excess heat, or the like. Accordingly, CMOS devices within a substrate can impose a thermal budget constraint to the manufacture of memory components upon a CMOS chip or substrate (e.g., by way of a backend of line fabrication process). Likewise, thermal budget constraints should be considered during the manufacture of a resistive memory device in an integrated circuit, for instance.

An integrated circuit (IC) foundry includes various equipment and processes that are leveraged in order to incorporate the resistive memory into the backend of line process. The inventors of the present disclosure are familiar with backend material compatibility issues associated there with. The one or more disclosed aspects can perform the process of fabricating the resistive memory device in a relatively simple manner compared to other resistive memory fabrication processes. For example, a common material(s), or common process step(s) can be employed in fabricating differently configured memory arrays (e.g., 1T1R, 1TnR) disclosed herein.

Further, one or more disclosed aspects can enable smaller die sizes and lower costs through one or more disclosed processes for monolithic integration of resistive memory onto a product of a frontend of line process (e.g., e.g., a MOS substrate, including CMOS, nMOS, or pMOS devices). Further, the fabrication of the resistive memory devices may be performed using standard IC foundry-compatible fabrication processes. Various embodiments can also be implemented without design changes after monolithic integration (e.g., over a CMOS device) to account for changes in parasitic structure. A parasitic structure is a portion of the device (e.g., memory device) that resembles in structure a different semiconductor device, which might cause the device to enter an unintended mode of operation. Further, in at least one disclosed embodiment, there is provided a product (e.g., a memory device) of a fabrication process that can comprise monolithic integration of resistive memory over a CMOS circuitry. Further, the fabrication process can comprise IC foundry-compatible processes in a further embodiment (e.g., new or different processes are not necessary, though in alternative embodiments future improvements to such processes should not be excluded from the scope of various aspects of the present disclosure). In addition, the disclosed aspects can be performed within a thermal budget of frontend of line devices.

In some embodiments, the active metal layer can comprise a metal nitride selected from the group consisting of: TiNₓ, TaNₓ, AlNₓ, CuNₓ, WNₓ and AgNₓ, where x is a positive number. In other embodiments, the active metal layer can comprise a metal oxide selected from the group consisting of: TiOₓ, TaOₓ, AlOₓ, CuOₓ, WOₓ and AgOₓ. In other embodiments, the active metal layer can comprise a metal oxi-nitride selected from the group consisting of: TiOₐN_{b}, AlOₐN_{b}, CuOₐN_{b}, WOₐN_{b} and AgOₐN_{b}, where a and b are positive numbers. In some embodiments, the switching layer can comprise a material selected from the group consisting of_{:} SiO_{y}, AlN_{y}, TiO_{y}, TaO_{y}, AlO_{y}, CuO_{y}, TiNₓ, TiN_{y}, TaNₓ, TaN_{y}, SiOₓ, SiNy, AlNₓ, CuNₓ, CuN_{y}, AgNₓ, AgN_{y}, TiOₓ, TaOₓ, AlOₓ, CuOₓ, AgOₓ, and AgO_{y}, where x and y are positive numbers, and y is larger than x. Various combinations of the above are envisioned and contemplated within the scope of embodiments of the present invention.

In an embodiment, the active metal layer can comprise a metal nitride: MNₓ, e.g. AgNx, TiNx, AlNx, and the switching layer can comprise a metal nitride: MN_{y}, e.g. AgNy, TiNy, AlNy, where y and x are positive numbers, and in some cases y is larger than x. In another embodiment, the active metal layer can comprise a metal oxide: MOₓ, e.g. AgOx, TiOₓ, AlOx, and the switching layer can comprise a metal oxide: MO_{y}. e.g. AgOy, TiOy, AlOy, where y and x are positive numbers, and in some cases y is larger than x. In still other embodiments, the metal compound of the active metal layer is selected from a first group consisting of: MN_{X} (e.g., AgNₓ, TiNₓ, AlNₓ), and the switching layer comprises MO_{y} (e.g. AgOₓ, TiOₓ, AlOₓ) or SiO_{y},, where x and y are typically non-stoichiometric values.

### General Overview

Today, many non-volatile memory markets are dominated by NAND Flash memory, hereinafter referred to as flash memory. Flash memory (e.g., three-terminal memory) has many characteristics that are different from certain two-terminal memory detailed herein. One potential result of differing characteristics is that memory management techniques, such as logical-to-physical (L2P), wear leveling (WL), and metadata management can differ as well between flash memory and two-terminal memory. While parts of this disclosure focus on L2P translation, it is understood that techniques detailed herein can also apply to physical-to-logical translation as well as metadata management.

One notable differing characteristic between flash memory and two-terminal memory relates to in-place overwrite of data, which is supported by some types of two-terminal memory, but not supported by flash memory. Due to disturb errors or other issues, a block (e.g., multiple pages) of flash memory generally must be erased first before writing data to any page of memory in that block. Additionally, wear leveling algorithms employed for flash memory typically add additional write operations as data is moved from high-use blocks to low-use blocks. Such measures can result in a write amplification (WA) factor of 3X. At a write amplification of 3X, each high level write instruction (e.g., from a host device) generally requires three low-level operations (e.g., a move operation, an erase operation, and a write operation) resulting generally in three times the wear on the memory. Such can dramatically affect memory endurance. In some embodiments, techniques detailed herein can provide a WA factor of one. In other words, substantially no write amplification at all or only negligible WA.

Since flash memory has dominated the marketplace, traditional memory management techniques, including L2P translation and WL, have been designed based on the characteristics of flash memory. For example, a consequence of a 3X WA has lead to a large over-provisioning (OP) in order to mitigate the 3X WA. Large OP causes capacity reduction since a significant portion of the total memory is allocated to OP instead of representing usable memory.

One significant use of L2P translation is to provide wear leveling as well as other memory management elements. Wear leveling typically seeks to more evenly spread wear (e.g., a number of memory operations such as writing or erasing) among the usable memory. Because flash memory does not support overwrites, etc., conventional memory management schemes must support not only static wear leveling (SWL), but also dynamic wear leveling (DWL). Traditional schemes can suffer from substantial performance degradation due to DWL. Such can be caused by garbage collection procedures, a so-called ‘write cliff, or other inconsistent performance issues.

Moreover, traditional flash memory management techniques generally require a large system footprint for FTL management. For example, a large amount of memory is needed for maintaining FTL tables. As one example, the FTL table can require an entry for each 4kB of data. For example, a flash memory device might allocate about twenty percent of the total memory capacity of a memory device to store various metadata such as that associated with L2P translation and WL. Since this storage area is not available to host device applications or data, 1.2 GB of total capacity is required in order to provide the host device (or a user) with 1.0 GB of usable storage capacity. Such can represent a significant reduction of (usable) storage capacity for flash memory devices and others. Moreover, previous techniques can further require very complex design to maintain these tables during power failure or, additionally or alternatively rely on super capacitors, battery backup, or NVDIMM.

In contrast, certain types of two-terminal memory can provide beneficial characteristics that can be leveraged to reduce the demands of memory management such as the demands caused by L2P translation, wear leveling, table maintenance during power failure, and so on. For example, certain types of two-terminal memory can have an endurance (e.g., an average number of write cycles before failure) of 100 K or more. Such memory can also support overwrite capabilities, so erase operations are not required. Such memory can further support very low read latency (e.g., about one microsecond or less) and low write time (e.g., about two microseconds or less).

Certain two-terminal memory (TTM), such as filamentary-based, resistive-switching memory, represents an innovative class of non-volatile storage. In some embodiments, such has many beneficial attributes compared to flash memory, which currently dominates many memory markets. In some embodiments, TTM can provide very fast read and write times, small page sizes, in-place writes, and high endurance. Even though the endurance of TTM is high compared to flash memory, the endurance is not so remarkably high that in practical use benefits cannot be obtained by using some form of wear leveling. Further, storage system that use TTM can benefit from other memory management features like data integrity across power cycles, detecting, anticipating, and/or managing various memory failures, and so forth.

This disclosure proposes a set of techniques to manage TTM storage systems. In some embodiments, largely due to certain advantages of TTM over other types of memory, the management layer can be very thin both in terms of computational and memory resources, while still effectively providing various benefits such as, e.g., L2P translation, wear leveling, power failure recovery, and so on that is normally associated with much larger management layers.

Since TTM supports in-place overwrite of data, DWL and garbage collection are not required. Such by itself represents a significant reduction that can be realized for memory management overhead. However, TTM can still benefit from efficient SWL, e.g., to ensure wear is spread across the available memory so that some parts of memory do not wear more quickly than others or the like. As with many other elements of memory management, implementation of SWL relies on L2P translation.

While other disclosures by the inventors focus on L2P translation and SWL, this disclosure is primarily directed to concepts associated with metadata handling. Techniques disclosed by the inventors regarding L2P mapping can be employed to, e.g., significantly reduce the size of the L2P mapping table. An associated advantage of such can be that, in some embodiments, the entire L2P mapping table can be stored in traditional volatile memory (e.g., DRAM, SRAM, etc.), which can result in extremely fast accesses. Techniques disclosed by the inventors regarding SWL can be employed to, e.g., reduce the size of SWL tables and to trigger SWL relatively infrequently. An associated advantage of smaller SWL tables can be that, in some embodiments, SWL tables can be stored in volatile memory for fast access. Associated advantages of the relatively infrequent triggering can, in some embodiments, require very little resource overhead to effectuate SWL and a significant reduction in wear as a result of the wear-leveling operations themselves.

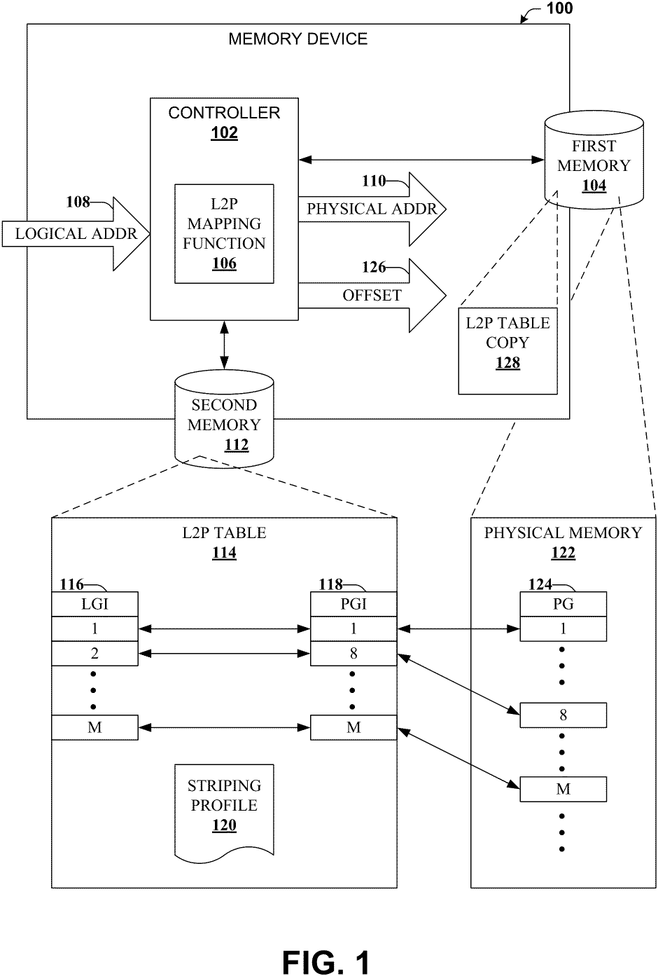

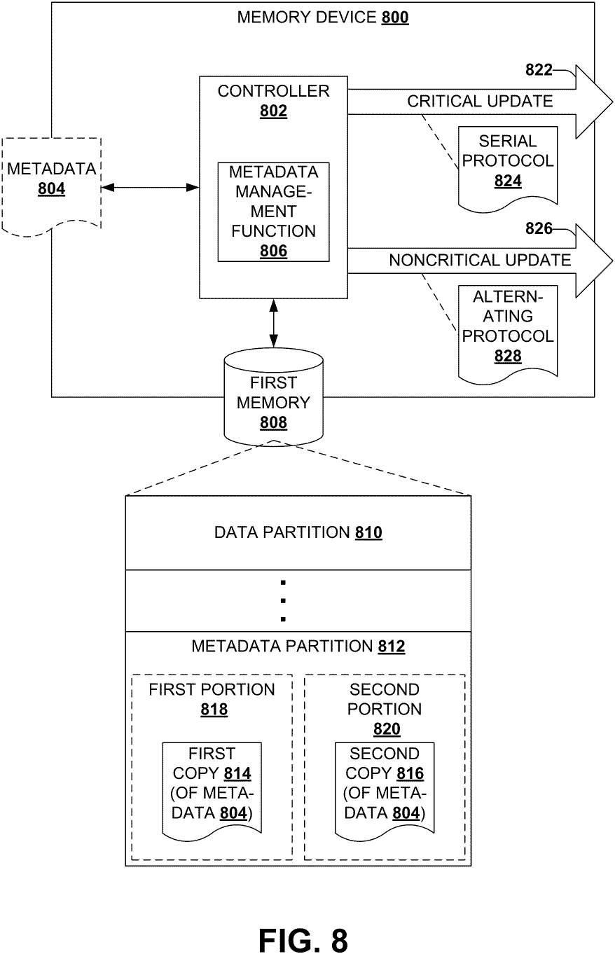

L2P translation and SWL are introduced below and described in more detail in connection with FIGS. 1-7. Concepts, techniques, and relevant elements introduced in FIGS. 1-7 can be leveraged to gain a thorough understanding of the disclosed metadata handling techniques, which is the primary subject of this disclosure, and is introduced briefly below and discussed in detail in connection with FIGS. 8-14.

For example, L2P translation, SWL, and other memory management procedures rely on metadata such as, e.g., L2P mapping tables, SWL tables, write counters, and so forth. How this metadata is managed can significantly affect the reliability, usefulness, and marketability of a memory device. For instance, the availability and integrity of such metadata largely determines the functional use of the memory device. Since all metadata used by certain embodiments disclosed herein can have a small enough footprint to very easily fit in volatile memory, techniques detailed herein can relate to managing one or more backup copies of the metadata that is stored in non-volatile (e.g., TTM) memory. When power to the memory device is cycled, whether inadvertently or intentionally, data in volatile memory is, of course, lost. Thus, upon power on, this metadata can be made available (e.g., to volatile memory or otherwise) from the copies stored in the non-volatile memory.

In some embodiments, the disclosed metadata management techniques can recover from a power down event in a manner that is both simple and durable. Other systems rely on the use of super capacitors or batteries such that, in the event of a power failure, power can be supplied long enough to enable vital metadata maintenance. However, super capacitors and batteries can increase costs, increase size, and/or reduce the applications of the memory device. In contrast to those systems, in some embodiments, the disclosed metadata management techniques can recover from substantially any state extant at the time of the power down event without the need or use of super capacitors or batteries.

Furthermore, the disclosed metadata management techniques, in some embodiments, can provide virtually instantaneous availability to the memory device at start-up and/or power on. Such can be due to a combination of various advantageous detailed herein. For example, a metadata partition that stores the metadata (e.g., L2P mapping tables/data, SWL tables/data, etc.) can be of a fixed size and a fixed location. Thus, no discovery is required after power on and the storage system can be ready instantly to serve I/O commands. Additionally, in some embodiments, I/O commands (e.g., high-level data reads or data writes) can be accommodated during the process of rebuilding the metadata and/or propagating the copy(ies) of metadata from the non-volatile memory to the volatiles memory. As still another example, the disclosed metadata management techniques, in some embodiments, can operate to minimize or reduce updates to the metadata, which can reduce wear to, and eventual failure of, the metadata partition.

### L2p Translation Overview

In order to realize efficient L2P translation and to other related ends, consecutive logical blocks (LB) of memory can be grouped into a logical group (LG). Logical groups can be of substantially any size and that size is not necessarily dependent on a physical layout of a device. A LB can be mapped to a physical block (PB) that represents one or more pages of a physical memory location in the TTM. As used herein a block, e.g., a LB or PB, can represent an addressable unit of data such as a page of memory or a collection of pages. In one embodiment, LB and PB represent a same unit of data. A group of PBs can be grouped together to form a physical group (PG) that corresponds to an associated LG. There need not be any restriction on how the PG is defined. For example, PBs of a given PG can be in a single bank of memory, on a single chip of memory, can span multiple chips of memory, or even span multiple channels (e.g., to enable parallelism elements). In some embodiments, PBs of a PG corresponds to the way data of logical pages is stripped across the physical pages.

Generally, a group size (e.g., a number of blocks in a group) can be configurable, but typically is the same for physical groups and logical groups. Typically, each LG is mapped to a corresponding PG. An L2P translation table can be employed to map a given LG to a corresponding PG. The L2P table can be kept in volatile memory for fast access. Moreover, this L2P table can have significantly fewer entries than previous translation tables such as those associated with flash memory. In other words, the L2P table can have one entry per group of blocks instead of one or more entries per page of flash memory, which can reduce the size of the L2P table over other systems as substantially a function of group size. Due to a smaller size, the L2P table can be kept in volatile memory inside the controller, whereas in embodiments using flash memory, an external memory component such as DRAM is typically required to accompany the controller which increases the cost of the system and its power consumption and reduces the performance. The L2P table can further be stored in TTM (e.g., non-volatile) to enable recovery, such as after a power failure or interruption. In some embodiments, the L2P can be kept on a non-volatile memory embedded in the controller.

In some embodiments, the group size of LGs and PGs can be static and the same across the entire storage system. In some embodiments, the storage system can be divided into multiple data partitions and the group size of LGs and PGs can be static but differ between different partitions. For example, a first partition of the available non-volatile memory can have one static group size whereas a second partition can have a different static group size. In some embodiments, the first partition and the second partition can have dynamic group sizes that can be same or different and can be determined and/or updated in situ and/or in operation based on traffic patterns or other suitable parameters.

### Static Wear Leveling Overview

In the course of normal TTM operations without SWL, L2P mapping is not changed and all updates to memory can be in-place overwrites. This may result in some PGs that experience much higher wear compared to other PGs. Thus, to even out the wear across the PGs, SWL can be implemented.

However, in some embodiments, SWL can represent overhead both in terms of performance and in terms of wear. For example, SWL procedures can operate to swap data between portions of the memory that are highly active with portions of the memory that are not highly active. Swapping of data itself causes wear as well as increasing demand on other resources. Hence, it can be advantageous to minimize or reduce SWL procedures, for instance, trigger SWL procedures very infrequently and/or only if required.

SWL can be implemented by comparing write counters to a SWL table of various thresholds. In some embodiments, the write counters can be 4-byte counters that are incremented when any portion (e.g., a block or a page) of a PG is written to in order to keep track of wear for a PG. In other words, each time a block or a page of a PG is written, the corresponding write counter is incremented by one. A separate write counter can be employed for each PG of the usable TTM (e.g., data partition(s)). Write counters can be stored in volatile memory during normal operations and can be backed up in a metadata partition of the TTM (e.g., non-usable or reserved partition(s)). In some embodiments, the write counters can be stored in a non-volatile memory.

Write counter data can include the write counters and a tier index that can keep track of a number of times a corresponding PG has underwent a WL procedure. For example, when a write counter of a PG surpasses a high count threshold and is swapped with a low count PG, then the tier index of both PGs can be incremented to indicate these PG’s are in a next higher tier. As will be explained below, such can prevent additional WL procedures from triggering unnecessarily.

The SWL table can maintain various WL tiers, and a high threshold value and low threshold value for each WL tier. In some embodiments, a fixed number of constant high and low thresholds can be established or configured during or after manufacture. Generally, SWL thresholds need not be placed at uniform intervals. Moreover, normal traffic may even out the wear in between these threshold intervals to, e.g., reduce the triggering of SWL procedures. As with write count data, a distinct instance of an SWL table can be maintained per PG, e.g., in order to track the SWL states for each PG.

As noted, any write (e.g., overwrite) to a portion of memory allocated to a particular PG can increase a write count corresponding to the PG. High and low threshold and tier indices can be employed to trigger and manage write distribution and thereby effectuate the static wear leveling. For example, when a write operation causes an associated write counter of a source PG to exceed the high threshold (e.g., maintained in the SWL table) for the indicated tier, then the SWL procedure(s) can be triggered.

A target PG with a write count that is lower than the low threshold for the tier is identified and data of the target PG is swapped with the data of the source PG. The tier indices for both PGs are increased to record completion of one write distribution cycle. The L2P table can be updated accordingly. As noted, thresholds do not need to be linear. Rather, the thresholds can be set such that the negative effects of triggering the SWL procedure (e.g., performance, wear, etc.) can be reduced and in some cases substantially negligible. In some embodiments, thresholds can be set or updated in situ and/or in operation. In some embodiments, the thresholds can be determined at run time based on traffic patterns witnessed at the TTM or other parameters. In some embodiments, a small part (e.g., about one PG in size) of the TTM (e.g., a non-data or reserved partition) can be reserved and used as temporary storage to facilitate the data swap between the source PG and the target PG. Such can be referred to herein as an SWL helper partition.

### Example L2p Translation Systems

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of disclosure may be practiced without these specific details, or with other methods, components, materials, etc. In other instances, well-known structures and devices are shown in block diagram form to facilitate describing the subject disclosure.

Referring initially to FIG. 1, memory device 100 is depicted that provides for a thin and efficient logical-to-physical (L2P) mapping. For example, memory device 100 can comprise controller 102. Controller 102 can be operatively coupled to first memory 104. First memory 104 can comprise an array of non-volatile two-terminal memory cells. In some embodiments, all or a portion of first memory 104 can be physically located within memory device 100. In some embodiments, all or a portion of first memory 104 can be remote from memory device 100. Controller 102 can comprise L2P mapping function 106 that can facilitate translating a logical memory address 108 to a physical memory address 110. Logical memory address 108 can be characterized as a logical address of data of a logical data space. Physical memory address 110 can be characterized as an address corresponding to physical memory 122 of first memory 104.

Controller 102 can further be operatively coupled to second memory 112. Second memory 112 can comprise volatile or non-volatile memory. For example, second memory 112 can have static random access memory (SRAM)-like characteristics, or can be implemented as a combination of SRAM and dynamic random access memory (DRAM) that are volatile or magnetoresistive random access memory (MRAM) that is very fast and non-volatile. In some embodiments, second memory 112 can be implemented as resistive random access memory (RRAM) and particularly one-transistor-one-resistor (1T1R) RRAM which are very fast. A 1T1R RRAM implementation can be advantages as, in some embodiments of the disclosed subject matter, updates do not happen as often and as such, endurance of about 100 K and using range program time should be sufficient in this application. A one-transistor-many-resistor (1TnR) RRAM typically has a longer read access time, which could cause performance issues. In the case of 1T1R, the memory can be monolithically integrated into the controller as well.

In some embodiments, all or a portion of second memory 112 can be included in memory device 100 and/or controller 102. The volatile memory of second memory 112 can store L2P table 114. L2P table 114 can comprise a first set of physical group identifiers (PGIs), which can be referenced herein, either individually or collectively, as PGI(s) 118. A given PGI 118 can identify a corresponding physical group (PG) 124 of first memory 104, which can comprise substantially any positive integer, M, of PGs 124. Various pages in a given PG 124 can be grouped together in the PG 124 according to a defined striping profile 120.

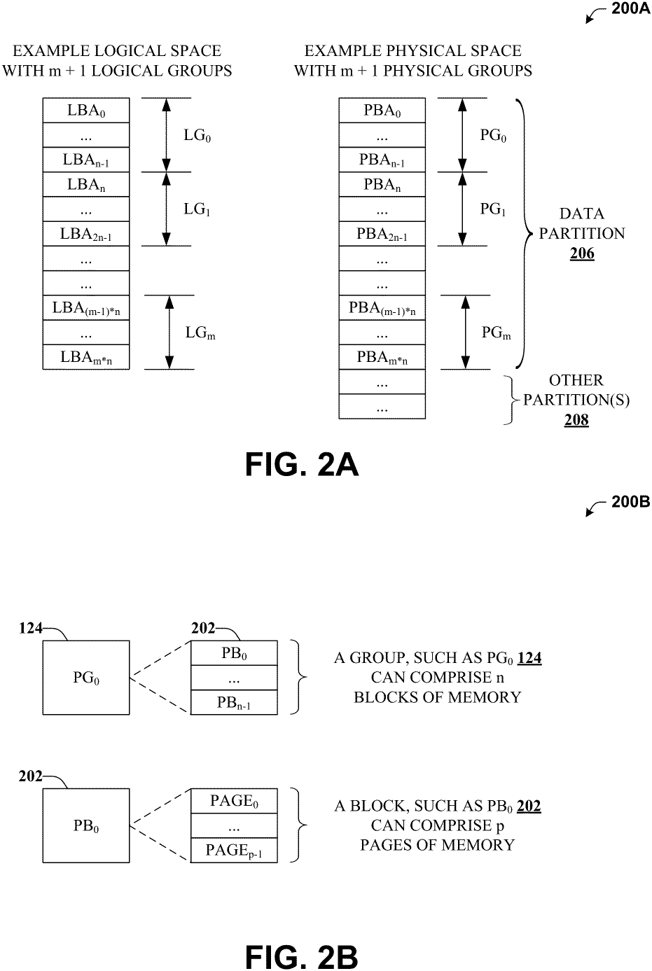

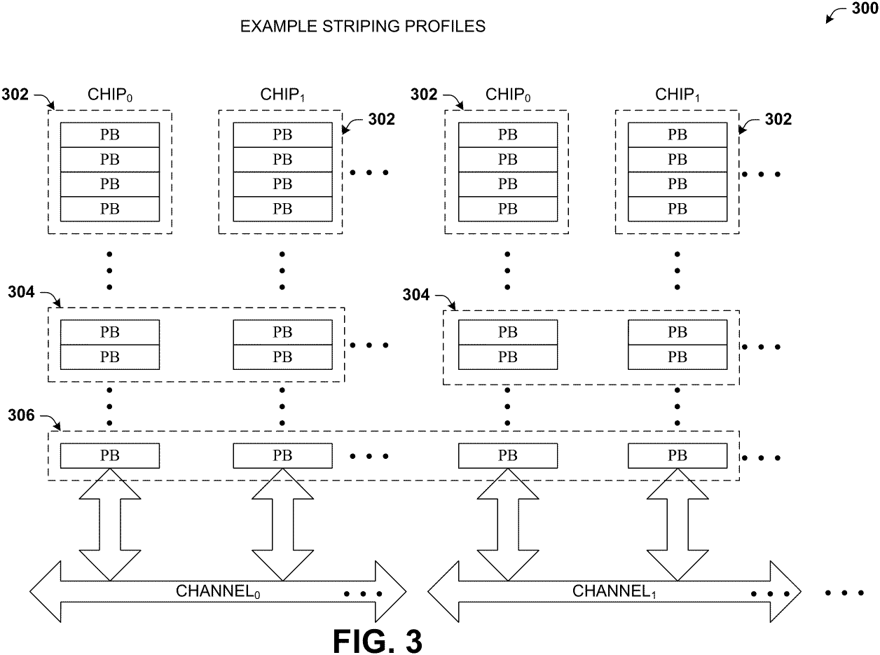

L2P table 114 can further comprise a second set of logical group identifiers (LGIs), which can be referenced herein, either individually or collectively, as LGI(s) 116. A given LGI 116 can identify a logical group (LG), having M consecutive logical pages of data, that maps to a corresponding PG 124. Additional detail regarding logical and physical memory spaces can be found with reference to FIGS. 2A and 2B. Additional detail regarding striping profile 120 can be found in connection with FIG. 3.

While still referring to FIG. 1, but turning now to FIG. 2A, block diagram 200A is presented. Block diagram 200A provides various examples relating to logical and physical spaces in connection with L2P mapping.

For purposes of reducing metadata and related overhead, in some embodiments, sequential logical block addresses (LBAs) can be combined together to form a logical group (LG). These sequential LBAs can be mapped to sequential physical page addresses (PPAs) and/or sequential physical block addresses (PBAs) locations in physical memory. These consecutive PPAs or PBAs in memory can form a physical group (PG). A PG 124 can be made up of consecutive PBAs and/or PPAs within a same chip or same bank or can be made up of locations across all the chips in a channel or can be made up of multiple chips across multiple channels, which is further detailed in connection with FIG. 3. In any case, the layout can be predefined and known such that only knowing the starting PBA or PPA of PG 124 is enough to find the location of any LBA mapped to the PG.

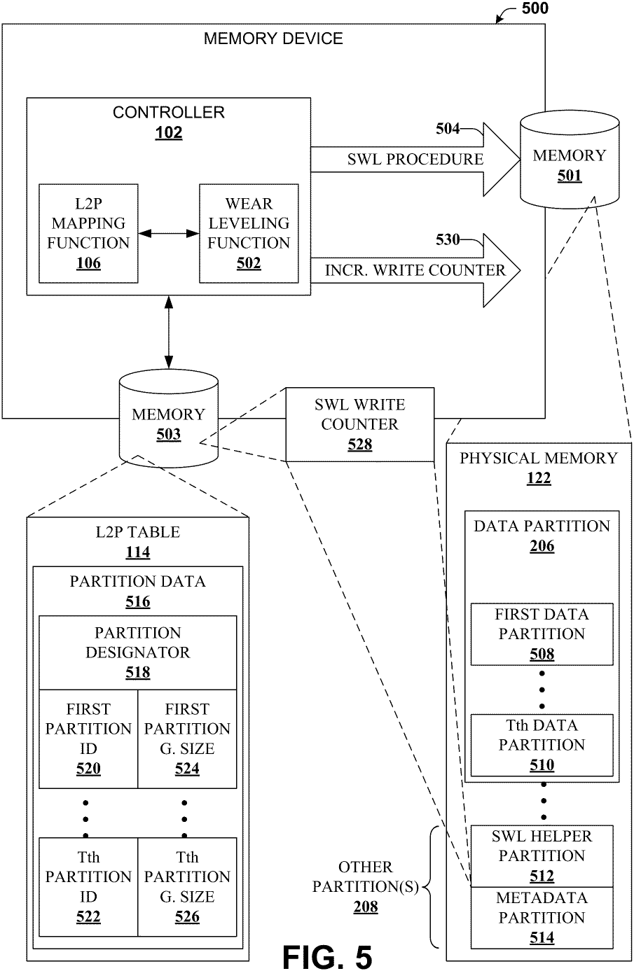

In this example, LG₀ can map to PG₀, LG₁ can map to PG₁, and so on. The collection of LG₀ through LGₘ can represent substantially of logical memory that can be mapped to PG₀ through PGₘ, which can represent substantially all usable physical memory of first memory 104. This usable physical memory can be referred to as data partition 206. In some embodiments, first memory 104 can include other partitions 208, which is further detailed in connection with FIG. 5.

Referring now to FIG. 2B, block diagram 200B is presented. Block diagram 200B provides example hierarchical views of a PG and a physical block. As detailed, a PG (e.g., PG₀ 124) can comprise substantially any positive integer, n, physical blocks 202 of physical memory. A given physical block (e.g., PB₀ 202) can be addressed by a physical block address (e.g., PBA₀). In some embodiments, a PB 202 can represent about 4 kB of information. In some embodiments, PB 202 can represent about 512 bytes of information. However, since TTM can support small pages a given PB 202 can comprise substantially any positive integer, p, pages of memory. Although not depicted here, in some embodiments, a page can be larger than a block, in which case a page can comprise multiple blocks. For example, in some embodiments, the size of the block can correspond to a defined data size utilized by a host. Given that TTM can support substantially any suitable page size, in some cases it may be advantageous to have page sizes larger than the block size.

As an assumption, if the number of LBAs in LG (and, likewise, the number of PBAs or PPAs in a PG) is small enough, it can be assumed, in some embodiments, that wear within a PG 124 is mostly uniform. In other words, that all the PBAs within a PG 124 will experience approximately the same wear, and thus SWL at a granularity of a given group size is sufficient to efficiently utilized a TTM storage system.

From observation, this assumption is valid for certain workload types, namely, types such as mostly sequential workloads, mostly random workload across the whole storage capacity, mostly random workload across subset of storage capacity and many other workloads when number of PBAs in a PG 124 is less than about 256 4 K LBAs. Hence, in some embodiments, a PG 124 can represent about one megabyte of data or less and can have fewer than or equal to 256 physical blocks (e.g., n ≤ 256) of 4 K block size.

While still referring to FIG. 1, but turning now as well to FIG. 3, block diagram 300 is presented. Block diagram 300 provides various example striping profiles. For example, reference numeral 302 depicts an example striping profile 120 in which all PBs of a PG are assigned to a single chip of memory, potentially on a single memory bank and potentially sequential. Reference numeral 304 depicts an example striping profile 120 in which a first portion of PBs are from a first chip (e.g., CHIP₀) and a second portion of the PBs are from a second chip (e.g., CHIP₁). In this example, both the first and second chips are accessed via the same channel (e.g., CHANNEL₀ or CHANNEL₁, etc.). Reference numeral 306 depicts an example striping profile 120 in which a single PG 124 spans multiple chips and multiple channels.

In contrast to other embodiments in which a page is the same size as a block or there multiple blocks per page, in cases where there are multiple pages per block (as illustrated in FIG. 2B), stripping can stripe data across the pages of different memory devices that can belong to different PGs. Such can represent another example stripping profile.

Continuing the discussion of FIG. 1, as noted, controller 102 can utilize L2P table 114 to map logical memory address 108 (e.g., an LBA) to physical memory address 110 (e.g., a PBA). It is understood that one or more copies of L2P table 114 (denoted as L2P table copy 128) can be stored in a non-volatile manner in first memory 104. Such can enable L2P table 114 to be restored in second memory 112 in the event of power failure or the like.

As also noted, knowing the starting PBA of a PG 124 is enough to find the location of any LBA mapped to the PG 124 based on a known striping profile 120 and vice versa. Such can be achieved according to the following. Upon receipt of a given LBA (e.g., logical memory address 108), a given LG can be identified by dividing the LBA by the number of LBAs per LG (e.g., n). Having determined the correct LG (identified by LGI 116), the corresponding PG can be readily identified based on striping profile 120 and other known data contained in L2P table. Having determined the correct PG 124 (e.g., identified by PGI 118), what remains is to determine offset 126 within the identified PG 124. Such can be accomplished by way of a modulo operation, e.g., a remainder of LBA divided by the number of LBAs per LG. For example, offset 126 can be LBA % n.

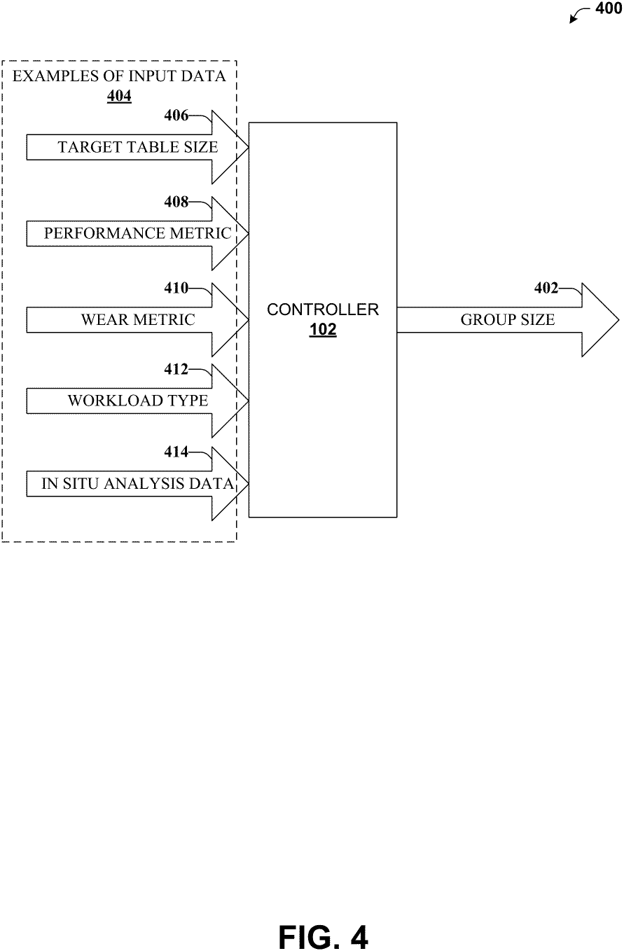

Referring now to FIG. 4, system 400 is illustrated. System 400 depicts various examples relating to a configurable group size in connection with L2P translation. As previously discussed, group size 402 can be configurable. Group size 402 is used herein as a number of blocks (e.g., n) that are grouped together in the same LG or PG 124. Other metrics relating to size might also be used. In some embodiments, group size 402 can be determined and/or updated by controller 102 based on input data 404.

In some embodiments, input data 404 can represent a determined value that is determined to result in a target table size. Such is labeled here as reference numeral 406. It can be readily appreciated that a table size of L2P table 114 is a function of the number of groups. Grouping fewer blocks into a group can result in more groups (e.g., smaller group size 402 and larger table size), whereas grouping more blocks per group can result in fewer groups (e.g., larger group size 402 and smaller table size). In general, a smaller table size can be preferred as such can reduce overhead and/or satisfy various performance metrics 408. However, in order to reduce table size, group size 402 must increase. Generally, it is not desirable to increase group size 402 beyond the point in which wear (within a group) is not reasonably uniform as indicated by wear metric 410. Hence, target table size 406 can relate to data indicating an optimal or target table size that balances these competing influences (e.g., performance metric 408 vs. wear metric 410).

In some embodiments, input data 404 can represent a defined workload type 412. The defined workload type 412 can be a substantially sequential workload, a substantially random workload across substantially all PGs of the first memory, a substantially random workload across a subset of PGs of the first memory, or another suitable workload type 412. Group size 402 can be determined based on an expected workload type 412 e.g., to optimize or improve efficacy for the identified type.

In some embodiments, controller 102 can determine or update group size 402 in situ. For example, input data 404 can represent in situ analysis data 414 that can be collected by observing first memory 104 in operation. For instance, controller 102 can, based on in situ analysis data 414, determine that first memory 104 is operating according to a particular workload type 412 and then update group size 402 accordingly.

Turning now to FIG. 5, memory device 500 is illustrated. Memory device 500 can provide for additional aspects or elements in connection with thin and efficient logical-to-physical (L2P) mapping. For example, memory device 500 and/or controller 102 can employ L2P mapping function 106 to provide wear leveling function 502. As a result of wear leveling function 502, a static wear leveling procedure 504 can be performed on memory 501, which can be non-volatile, TTM such as that described in connection with first memory 104 of FIG. 1.

As previously detailed, because memory 501 can comprise TTM, which allows overwrite operations, DWL, garbage collection, and certain other memory management operations are not needed. However, memory 501 can still benefit from static wear leveling, which can be referred to herein with reference to SWL procedure 504. SWL procedure 504 can operate to more evenly spread memory wear among the physical memory 122 (of first memory 104 and/or memory 501), which can improve memory endurance not only for data partition 206, but also for other partitions 208.

In some embodiments, data partition 206 can represent a single logical partition comprising all or substantially all usable memory (e.g., what is available to high-level applications for storage). Other partitions 208 can exist as well, with the potential caveat that memory allocated to these other partitions 208 reduces overall capacity of data partition 206.

Data partition 206 is typically the largest partition. Data partition 206 can comprise all PGs 124. Hence, if there are M LGs allocated for memory device 500 based on exposed capacity of the storage medium and no data reduction is employed, then there are M PGs 124 in data partition 206. Data partition 206 can be organize and managed in terms of PGs 124. Because PGs 124 can be relatively large in size, management operations (e.g., L2P translation, wear-leveling, etc.) can be thin and efficient. Among other partitions 208, physical memory 122 can include an SWL helper partition 512, a metadata partition 514, or other suitable partitions.

In some embodiments, SWL helper partition 512 can be used as a temporary placeholder while moving data during SWL procedure 504. SWL helper partition 512 can represent a relatively small partition in terms of size. The size of SWL helper partition 512 can be configurable and can be based on a number of parallel SWL operations to be supported by memory device 500 as well as other factors affecting wear. SWL helper partition 512 can be organized and managed in term of PGs 124. In some embodiments, metadata partition 514 can store metadata that is used for memory management operations such as SWL procedure 504. Metadata partition 514 can be relatively small and can be organized and managed in terms of TTM pages, which, as noted previously, can be smaller in size than conventional flash memory pages.

While data partition 206 has been described as a single logical partition, in some embodiments, data partition 206 can be logically divided into substantially any positive integer, T, partitions, which are exemplified by first data partition 508 and Tth data partition 510. Partitioning data partition 206 into multiple logical partitions (e.g., first data partition 508 through Tth data partition 510) can provide certain advantage, some of which are noted below. In those cases in which data partition 206 is further partitioned, L2P table 114 can comprise partition data 516.

Partition data 516 can comprise partition designator 518 that can indicate that data partition 206 is logically divided into multiple data partitions. In some embodiments, partition designator 518 can indicate the number (e.g., T) of logical partitions data partition 206 includes. In some embodiments, partition data 516 can comprise first partition identifier 520 and Tth partition identifier 522 that can identify a specific partition. As one example, a given PGI 118 that identifies a corresponding PG 124 can include a partition identifier (e.g., 520, 522) to indicate to which logical partition the PG 124 belongs.

In some embodiments, group size 402 can differ for different logical partitions. For example, suppose data partition 206 is divided into two logical partitions, 508 and 510. While a first group size can be uniform for all PGs 124 in partition 508, such can differ from a second group size that reflects group size 402 of partition 510. Hence, partition data 516 can comprise first partition group size data 524 that indicates a group size 402 of first data partition 508 and Tth partition group size data 526 that indicates a group size 402 of Tth partition 510. Group size data (e.g., 524, 526) can be the same or different and can be determined or updated independently. Moreover, such can be beneficial in that various logical partitions can be potentially optimized for the types of workloads that are individually witnessed in operation similar to what was described in connection with FIG. 4.

In some embodiments, memory 503, which can be substantially similar to second memory 112, can comprise SWL write counter 528. In some embodiments, a respective SWL write counter 528 can exist for each PG 124. In other words, if data partition 206 comprises M PGs 124, then M SWL write counters 528 can exist. SWL write counter 528 can represent a running tally of a number of times a corresponding PG 124 has been programmed (e.g., write operation, overwrite operation, or otherwise changes state). Hence, controller 102 can increment SWL write counter 528, which is represented by reference numeral 530. Incrementing 530 can be in response to a corresponding PG 124 being programmed. Since PG 124 represents a group of physical blocks and, in some cases, each physical block can comprise multiple pages, SWL write counter 528 can incremented in response to any page or any physical block being programmed, or even any bit or byte within a page being programmed to a different state.

SWL write counter 528 can be included in L2P table 114 or can be maintained in other portions of memory 503. One or more backup or copy of SWL write counter(s) 528 can also exist memory 501, such as in metadata partition 514.

### Example Wear Leveling

Still referring to FIG. 5, in the context of wear leveling, memory device 500 can comprise memory 503 (e.g., volatile memory). Memory 503 can store L2P table 114 that maps an LGI to a PGI. The PGI can identify a PG among PGs of memory 501 (e.g., non-volatile TTM). The PGs can respectively comprise multiple PBAs that address respective blocks of memory.

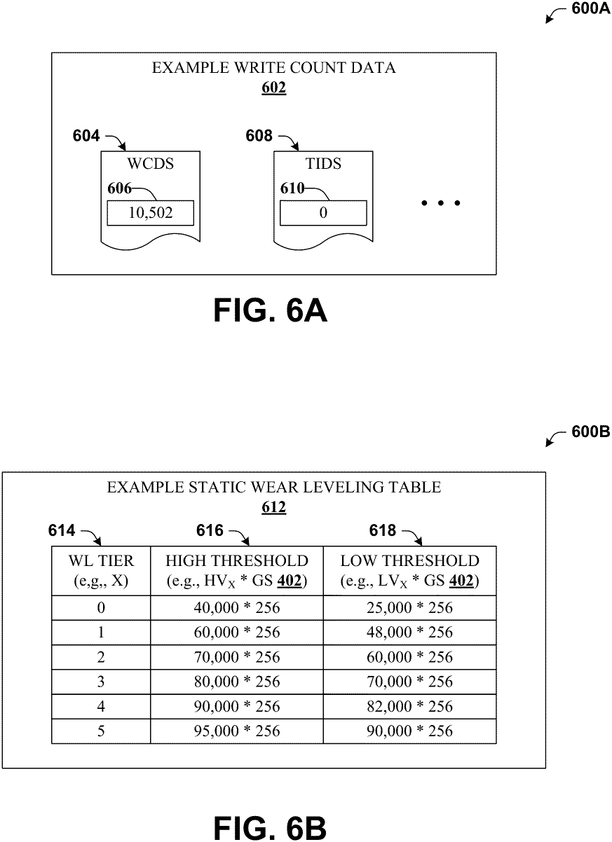

As previously indicated, memory device 500 can comprise controller 102 that can be coupled to memory 501 and memory 503. Controller 102 can facilitate performance of operations that provide SWL procedure 504. SWL procedure 504 can comprise determining that a block of data has been written to a PBA of the multiple PBAs. The write can represent substantially any amount of data such as a page of data, multiple pages of data, or the like. SWL procedure 504 can further comprise determining the PG (e.g., PG 124) that comprises the PBA. SWL procedure 504 can further comprise updating write counter data, which is further detailed in connection with FIG. 6A.

While still referring to FIG. 5, but turning now as well to FIG. 6A, block diagram 600A is presented. Block diagram 600A provides an example of write counter data 602. In some embodiments, write data 602 can comprise a write counter data structure (WCDS) 604. WCDS 604 can store a value representative of a count of writes and/or the aforementioned write count, which is represented herein as write count value 606. In this example, write count 606 is 10,502, which can indicate that memory addresses such as PBAs or PPAs that are included in a corresponding PG have witnessed 10,502 writes thus far.

In some embodiments, write count data 602 can comprise a tier index data structure (TIDS) 608. TIDS 608 can represent and/or store a wear leveling tier value 610 associated with write count 606. In some embodiments, tier value 610 can represent a number of times data of a corresponding PG 124 has been swapped and/or a number of times the corresponding PG 124 has been subject to a static wear leveling procedure even if the associated data is not swapped (e.g., because low count threshold is not satisfied). In this example, the wear leveling tier value 610 is “0”, which is further explained below in connection with FIG. 6B. However, still referring to FIG. 5, recall that SWL procedure 504 can include updating write counter data 602. In more detail, write counter data 602 can be updated by incrementing a write count value 606 that is stored in WCDS 604. Other WL systems such as those for flash memory typically increment a counter in response to an erase operation. In contrast, WL procedure 504 updates in response to write operations.

It is understood that once write count value 606 reaches a target threshold, SWL procedure 504 can determined if a swap procedure is to be processed. Such can be determined, at least in part, based on a comparison with data stored in a SWL table, an example of which can be found with reference to FIG. 6B.

Turning now to FIG. 6B, block diagram 600B is presented. Block diagram 600B provides an example of SWL table 612. SWL table 612 can comprise various data structures such as WL tier 614. In some embodiments, WL tier 614 can be substantially similar to tier value 610 in that such can represent a wear leveling tier. SWL table 612 can further include a high threshold value 616 and a low threshold value 618 for each WL tier 614.

In some embodiments, high threshold value 616 can be the product of a high value (for a given WL tier 614) multiplied by group size 402 (e.g., a number of PBAs or pages in a PG, in this case 256 4 K blocks or pages). In this example, the high value for tier 0 is 40,000, the high value is 60,000 for tier 1, and so on. It is understood that because a group size 402 can be selected such that wear can be reasonably uniform within a PG based on the type of load, it can be assumed that on average every 256 (or other group size 402) writes to a given PG will equate to about one write per PBA. Hence, when high threshold value 616 (e.g., 40,000 * 256) for tier zero is reached, then it is assumed that each PBA within the PG will have been written 40,000 times. In embodiments in which a PB comprises one or more pages, write count value 606 can be incremented when a page is written to, and it can be assumed that wear among the pages within a physical block is relatively evenly distributed depending on the work load type.

As noted previously, when any PBA or any page of a PG is written, an associated write count value 606 (e.g., of write count data 602 associated with that PG) can be incremented. When write count value 606 is compared to SWL table 612 and determined to exceed high threshold value 616 for the associated tier (e.g., tier value 610 = WL tier 614), then a tier incrementing procedure can be triggered. For example, when write count 606 exceeds (40,000 * 256) then the tier incrementing procedure can be triggered. For example, the tier incrementing procedure can increment the tier value 610 from “0” to “1”. Because tier value 610 is now set to “1”, subsequent writes to the associated PG can be compared to a different high threshold value 616 in SWL table 612. For instance to a higher value equal to (60,000 * 256) rather than the tier 0 high value of (40,000 * 256).

In some embodiments, exceeding high threshold value 616 can also trigger a data swap procedure, but such can be subject to satisfying a different value contained in SWL table 612, namely a low threshold value 618. For example, when a write count value 610 of a source PG (of tier 1) exceeds the high threshold value 616 (of tier 1), then controller 102 can identify a target PG with a lowest write count value 606 that is in the same or lower tier (e.g., “0” or “1”) as the source PG. If the write count 606 of the target PG is not less than the associated low threshold value 618, then the data is not swapped but the tier value 610 of the source PG can be incremented. One reason data is not swapped can be for the sake of efficiency. For instance, if the write count 606 of the target PG is above the low threshold value 618 and therefore within a defined count of the high threshold value 616, then it can be determined that the benefits of swapping data in that case is outweighed by the cost of swapping.

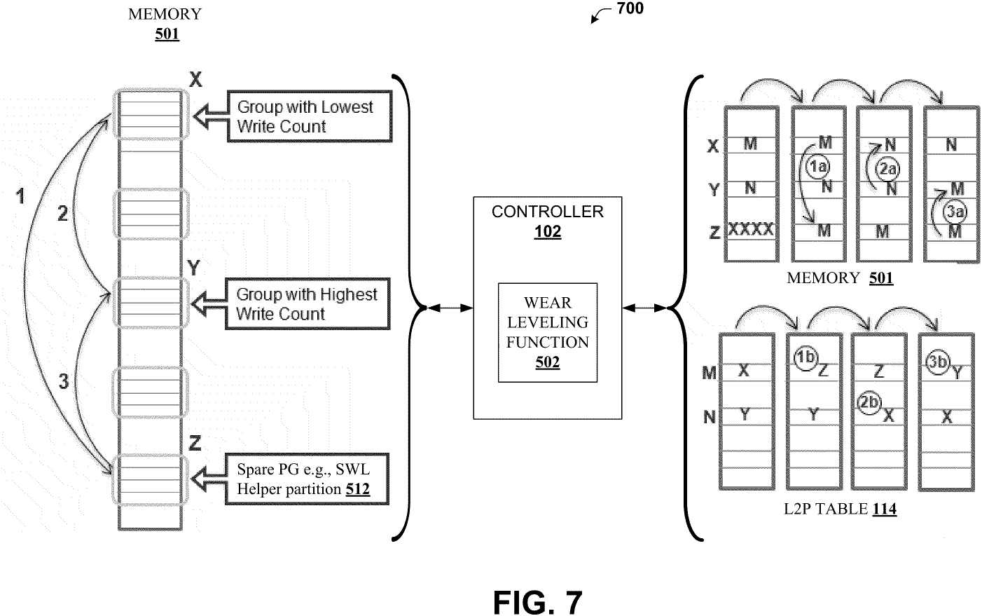

On the other hand, if the write count 606 of the target PG is below the low threshold value 618, then it can be determined that the benefits of swapping data in that case is not outweighed by the cost of swapping, so data can be swapped between the target PG and the source PG. An example swapping procedure is detailed in connection with FIG. 7.

Turning now to FIG. 7, block diagram 700 is illustrated. Block diagram 700 depicts an example swapping procedure that can be facilitated by controller 102 in connection with WL function 502. As detailed above, controller 102 can identify a source PG, e.g., when a write count 606 of the source PG exceeds a high threshold value 616 of SWL table 612. In this example, this source PG is identified as PG “Y” of memory 501 (e.g., non-volatile TTM). PG “X” is also identified by controller 102 as the target PG (of a same or lower tier) with a lowest write count 606. Provided the write count 606 of X is less than low threshold value 618, then data swapping can ensue between X and Y. Diagram 700 also illustrates spare PG denoted as “Z”, which can temporarily hold the data from one of X or Y. In this example, Z temporarily stores the data from X, but data from Y could be stored in other embodiments. In some embodiments, Z can be a non-data partition of memory 501, such as other partitions 208. In some embodiments, Z can be included in SWL helper partition 512. In some embodiments, Z can be included in memory 503 (e.g., volatile memory). As illustrated on the left side of FIG. 7, at step 1, data of X is copied to Z. At step 2, data of Y is copied to X. At step 3, data of Z, which was previously copied from X, is copied to Y. In some embodiments, step 3 is not performed, and changes to L2P table 114 detailed below can be adjusted accordingly.

On the right side of FIG. 7, more detail is given with respect to updating both memory 501 and L2P table 114. With regard to memory 501, in the initial state, X stores data M, Y stores data N, and Z does not store any pertinent data. With regard to L2P table 114, data M is pointed to by a PGI that identifies X, data N is pointed to by a PGI that identifies Y. At step 1a, data M is copied to Z. At step 1b, L2P table 114 is updated to reflect that data M is pointed to by a PGI that identifies Z. At step 2a, data N is copied to X. At step 2b, L2P table 114 is updated to reflect that data N is pointed to by a PGI that identifies X. At step 3a, data M is copied to Y. At step 3b, L2P table 114 is updated to reflect that data M is pointed to by a PGI that identifies Y.

It is understood that in certain higher performance systems, pipelining techniques can be used. Hence, many different commands can be in the pipeline at a given time. Hence, it can be advantageous to synchronize data swaps and L2P table updates in accordance with various pipelining techniques.

For example, in normal operation, a FIFO host command queue can receive commands from a host. Controller 102 can lookup PG(s) corresponding to the LG(s) in the L2P table. It is noted that a single host command may correspond to one or more LGs. Controller 102 can split the host command into one or more sub-commands, using the PG, and place the sub-commands in a physical command (PCMD) queue. Commands from the PCMD queue can be dispatched to different portions of devices of memory 501 based on sub-command physical address. Once a high threshold value for any PG is reached, controller 102 can initiate a first move from a source PG with a highest write count (or target PG with a lowest write count) to the spare PG.

In some embodiments, physical commands are processed in order (e.g., in order of receiving associated host commands). In those embodiments, controller 102 can read data from the source PG and copy to the spare PG. Generally, all host reads are directed to the source PG, and all writes to the source PG can be also written to the spare PG. Controller 102 can track all reads to the source PG since the move of data of the source PG to the spare PG has initiated. A counter can be implemented that increments with a read command and decrements when the read is completed. Once all data is moved from the source PG to the spare PG, controller 102 can change the L2P table entry corresponding to an associated LG to point to the spare PG. Controller 102 can wait until all reads to the source PG since the move was initiated are completed, which can be determined by the counter reaching zero. In response, controller 102 can initiate a move of data from the target PG to the source PG in a manner similar to the move of data from the source PG to the spare PG. It is understood that waiting for all reads to the source PG to complete prior to beginning the move of data from the target PG to the source PG can be significant. For example, if there are still some read commands in the PCMD queue for the source PG, then swapping data from the target PG to the source PG could result in incorrect data being served for those reads.

In some embodiments, physical command re-ordering can be allowed, which can be distinct from the previous paragraph in which physical commands are processed in order. In these embodiments, a read of data might be re-order to come before a write of the data even though the host sent the write command before the read command. For example, when physical commands are processed out of order, controller 102 can keep track of commands in the pipe. In some embodiments, commands can have a phase, and controller 102 can keep track of commands having a same phase and the completion of each phase. For a source PG, when a given high threshold is reached, controller 102 can flip the phase and wait for completion of all commands having the other phase. Upon completion, controller 102 can read data from source PG and copy that data to the spare PG. All host reads can be directed to the source PG and all host writes to the source PG can be directed instead to the spare PG. Once all data is moved from the source PG to the spare PG, controller 102 can change the L2P table entry corresponding to a LG such that the LGI points to the spare PG. Controller 102 can then flip the phase once more and wait for completion of all commands having the previous phase. Controller 102 can then initiate a move from the target PG to the source PG and move data from the spare PG to the source PG following the same or similar steps.

It should be understood that the above-mentioned different embodiments can have certain advantages. For example, a first embodiment that uses a counter can utilize a counter that only keeps track of reads to the PG with data that is being moved. Hence, the time to wait for completion will typically be shorter relative to a second embodiment that uses phases. Since these processes and waits can all be performed in the background and happen infrequently, the extra waits in the second embodiment are not detrimental to system performance. In the second embodiment, waits can be longer since the phase relates to all commands and not just commands in the pipe before switching the phase are completed. The second embodiment can work either in embodiments that re-order physical commands or embodiments that maintain the physical command order.

### Example Metadata Management

Turning now to FIG. 8, memory device 800 is illustrated. Memory device 800 can provide for metadata handling and other metadata management functionality in accordance with certain embodiments of this disclosure. Advantageously, aspects and techniques detailed herein can operate in connection with the lightweight L2P mapping and SWL elements detailed herein. For instance, metadata management can be such that the state (e.g., as described by metadata) of a memory device can, substantially instantaneously, be presented upon power on, and the memory device can therefore be substantially instantaneously ready for use (e.g., reading and writing data) without relatively lengthy discovery and initialization processes. Furthermore, the disclosed techniques can maintain metadata describing a present state of a memory device and that state can be preserved in the face of power failure without reliance on super capacitors or batteries.

Memory device 800 can comprise elements that are similar in nature to memory devices 100 and 500. In that regard, repetitive description of like elements employed in other embodiments described herein is omitted for sake of brevity. For example, memory device 800 can comprise controller 802. Controller 802 can manage metadata 804, e.g., via metadata management function 806. Metadata 804 can be used to facilitate memory management procedures in connection with first memory 808. In some embodiments, such memory management procedures can include a L2P mapping procedure (e.g., see embodiments detailed in connection with FIGS. 1-4), a P2L mapping procedure, or a wear-leveling procedure such as a SWL procedure (e.g., see embodiments detailed in connection with FIGS. 5-7). Additionally or alternatively, the memory management procedure can relate to metadata handling procedure or a power failure recovery and/or power on procedure, which is further detailed below.

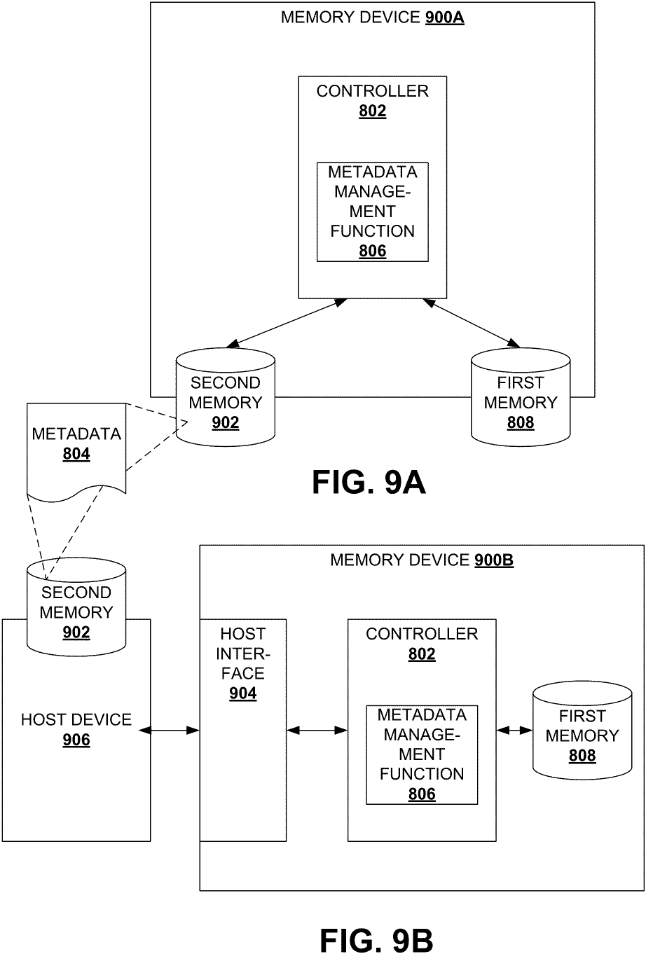

In some embodiments, metadata 804 can relate to or comprise various elements or data detailed herein such as L2P mapping data (e.g., L2P mapping table 114, etc.), SWL data, which can include SWL tables as well as write counter data (e.g., SWL write counter 528). In some embodiments, metadata 804 can be stored in first memory 808 (e.g., as a first copy 814 and/or a second copy 820). In some embodiments, metadata 804 can be stored in a second memory (not shown, but see FIGS. 9A and 9B).

Thus, it is understood that controller 802 can employ metadata 804 to correctly access data stored in first memory 808 despite changes in the physical memory address of that data due to, e.g., wear leveling operations, as well as other functions. First memory 808 can be operatively coupled to controller 802 and can comprise an array of non-volatile TTM. In some embodiments, all or a portion of first memory 808 can be physically located within memory device 800. In some embodiments, all or a portion of first memory 808 can be remote from memory device 800. In some embodiments, first memory 808 can be substantially similar to first memory 104 of FIG. 1 or memory 501 of FIG. 5.

For example, memory 501 can comprise physical memory 122, which can comprise various distinct partitions such as data partition 206 and other partitions 208. Similarly, first memory 808 can comprise data partition 810. In some embodiments, data partition 810 can be substantially similar to data partition 206. Data partition 810 can be representative of usable memory that is available to store host data provided by a host device (not shown, but see FIG. 9B). For instance, data usable by, or accessible to, a user of the host device or memory device 800 or data usable by, or accessible to, applications executed by the host device or memory device 800 can be stored to data partition 810. In other words, data partition 810 can represent a storage area for high-level (e.g., host) applications.

First memory 808 can further comprise metadata partition 812. In some embodiments, metadata partition 812 can be substantially similar to metadata partition 514. In some embodiments, metadata partition 812 can comprise data and/or metadata described in connection with other partitions 208. For example, metadata partition 812 can comprise information similar to SWL helper partition 512 as well. Information stored in metadata partition 812 can be representative of non-usable memory that is not available to store the host data (e.g., user or application data) provided by the host device. In other words, metadata partition 814 can represent a reserved area of memory that can be used to manage low-level accesses to first memory 808 or similar operations.

Moreover, metadata partition 812 can be configured to store first copy 814 and second copy 816. First copy 814 and second copy 816 can represent two separate copies of metadata 804. In some embodiments, first copy 814 can comprise an entirety of metadata 804. In some embodiments, first copy 814 can duplicate the information stored in second copy 816, however, during operation, the two copies 814 and 816 can differ slightly from time-to-time, which is further detailed herein.

In some embodiments, metadata partition 812 can have a defined size that is fixed. In some embodiments, metadata partition 812 can have a defined location within first memory 808 that is fixed. One advantage of having a fixed size and fixed location is that discovery, such as after power on, is not required and thus suitable metadata can be located and accessed very quickly. Moreover, because the inventors have developed a way to significantly reduce the size all metadata needed to manage the memory of a memory device, metadata 804 can be substantially smaller than that for other systems. Moreover, even though multiple copies of metadata 804 can be stored to metadata partition 812, metadata partition 812 can be significantly smaller than other systems that utilize a metadata partition. In some embodiments, metadata partition 812 can be less than about one percent of the total capacity of first memory 808, representing a significant reduction relative to other systems. Furthermore, in some embodiments, metadata partition 812 can be page-addressable, which further distinguishes from other systems such as those that employ flash memory.

In some embodiments, metadata partition 812 can divided into multiple (e.g., two or more) sections, which can represent demarcations between various different physical memory portions. In this example, metadata partition is divided into two different portions, labeled first portion 818 and second portion 820. In some embodiments, first portion 818 and second portion 820 can be equal in size or substantially equal in size. In some embodiments, one or both the size and location of first portion 818 and second portion 820 can be fixed, which can facilitate rapid access, e.g., after power on.

As depicted, in some embodiments, first copy 814 can reside in first portion 818 and second copy 816 can reside in second portion 820. Because first portion 818 and second portion 820 can represent physically (as opposed to merely logically) distinct areas of first memory 808, the two portions 818 and 820 can be in separate fault domains of first memory 808. In some embodiments, first portion 818 can reside in a separate memory chip or a separate memory bank as second portion 820. In some embodiments, first portion 818 can be accessible via a different channel or bus than is used to access second portion 820. Accordingly, it is understood that a high degree of accessibility and data integrity can be maintained in connection with the copies 814 and 816 of metadata 804 that reside in first memory 808. Such can represent a significant benefit, as the life and usefulness of first memory 808 can directly rely on the availability and integrity of metadata 804 and/or copies 814 and 816.

In some embodiments, metadata 804 can reside in other memory, while copies 814 and 816 can represent back-up copies of metadata 804 stored in first memory 808. Examples of such can be found in connection with FIGS. 9A and 9B.

While still referring to FIG. 8, but turning now as well to FIGS. 9A and 9B, memory devices 900A 900B are depicted. Memory device 900A illustrates a second memory that is coupled to the controller 802 in accordance with certain embodiments of this disclosure. For example, memory device 900A can comprise second memory 902 or can be operatively coupled to second memory 902. Memory device 900B illustrates a second memory that is operatively coupled to a host device 906 that is accessible to the controller 802 via a host interface 904 in accordance with certain embodiments of this disclosure.

To provide conceptual examples, in some embodiments, first memory 808 can represent a mass storage device or devices. Such devices can primarily function as bulk memory for applications or users, which may sacrifice to some degree speed for higher capacity and is typically directed to non-volatile storage. In view of the herein disclosure in which the size or footprint of metadata 804 can be reduced significantly, the inventors believe it can be more practical now to store metadata 804 elsewhere. For example, second memory 902, which can favor rapid access over capacity, which is generally (although not always) volatile memory. For instance, second memory 904 can be an on-board cache or the like that can be accessed very rapidly. In some embodiments, second memory 902 can be the same or substantially similar to second memory 112.

It is noted that because second memory 902 can be accessed relatively rapidly, storing metadata 804 in second memory 902 can provide a significant advantage over storing metadata 804 only in first memory 808. For example, accesses to first memory 808 can be faster, given metadata 804 (e.g., L2P mapping tables, etc.) can reside in faster memory. Today, however, such memory is generally volatile and therefore loses the stored information in the absence of power. Thus, it can be beneficial in embodiments in which second memory 902 is volatile memory to keep one or more copies (e.g., copies 814 and 816) of the metadata 804 in non-volatile memory such as first memory 808. Hence, metadata 804, which can essentially represent a state of first memory 808, can be restored to the volatile memory from the non-volatile memory after a power cycle. Such can be further beneficial if the copies 814 and 816 that are stored in non-volatile memory are managed and updated in a manner that does not require super capacitors or batteries to enable critical operations in response to power failure.

Still referring to FIG. 8, controller 802 can employ metadata management function 806 to update metadata 804. For example, when a SWL operation swaps a PG with another PG, metadata 804 (e.g., an L2P table) can be updated to reflect the new physical location of the swapped data. In embodiments in which metadata 804 is stored in volatile memory (e.g., second memory 902) then at least one copy (e.g., 814 and 816) residing in non-volatile memory (e.g., first memory 808) typically needs to be updated as well. For the remainder of this disclosure, it is assumed that metadata 804 resides in a volatile memory (e.g., second memory 902) that is distinct from first memory 808. However, it is understood that the updates one or more copies (e.g., copies 814 and 816) can be effectuated in the manner described irrespective of whether metadata 804 is also stored elsewhere. In other words, elements detailed herein in connection with embodiments in which volatile memory is used to store metadata 804 (e.g., for rapid access to metadata 804) can be employed in other embodiments as well, such as embodiments in which the second memory 902 is non-volatile or embodiments in which metadata 804 is not stored elsewhere other than first memory 808.

Hence, in some embodiments, controller 802, upon updating metadata 804 in second memory 902 can immediately update one or more of first copy 814 or second copy 816 in first memory 808. Thus, should a power cycle occur, a complete and accurate formulation of metadata 804 can be recovered and restored to second memory 902.

In response to an operation implemented on first memory 808 that changes metadata 804, controller 802 can appropriately update metadata 804. Such an update can entail updating metadata 804 as well as one or more of first copy 814 and second copy 816. In some embodiments, controller 802 can determine whether the update is a critical update 822 or a noncritical update 826. In response to a determination that the update is critical update 822, controller 802 can update according to serial protocol 824. On the other hand, in response to a determination that the update is noncritical update 826, controller 804 can update according to alternating protocol 828.

When determining whether a particular update is critical (e.g., critical update 822) or not (e.g., noncritical update 826), controller 802 can examine the type of change that is to be stored. For example, in some embodiments changes to L2P mapping data (e.g., L2P table 114) can be deemed to be critical and therefore updated according to serial protocol 824. On the other hand, changes to a write count (e.g., SWL write counter 528) can be deemed to be non-critical and thus updated according to the alternating protocol. It is appreciated that, while it can be important to maintain a reasonably accurate write count to effectuate SWL in an effective manner, the count does not need to be exact. Rather, controller 802 can trigger an update in response to a write count changing some number N times, where N can be a whole number, and typically greater than one (e.g., 10 or 20, etc). Thus, even if a power cycle occurs after a write count is updated in volatile memory but before such is updated in non-volatile memory, provided N is not too large, the difference between the two generally will not be significant enough to affect the operation of SWL procedures. Said differently, even if a few or a few tens of write count increments are lost for one or more PGs, the SWL procedure can still operate effectively. It can be appreciated that the benefits of not updating the metadata partition 812 for every single change to a write count can more than outweigh the potential detriments.

Serial protocol 824 can be employed in connection with critical update 822 and can operate as follows. Controller 802 can determine that first copy 814 is to be updated first. Such can be accomplished based on sequence numbers that track the order of updates to metadata partition 812. For instance, if second copy 816 was the last copy of metadata 804 to be updated, then its sequence number can be higher or otherwise reflect that fact, which can indicate that first copy 814 (e.g., the oldest version) is to be selected. Controller 802 can update first copy 814 with the appropriate changes (e.g., in a manner the same or similar to the update of metadata 804 in second memory 902). Then, controller 802 can determine or verify that first copy 814 has been successfully updated. If so, then, upon successful completion of the update to first copy 814, controller 802 can update the sequence number of first copy 814 (e.g., to reflect that first copy 814 is now the newest version of metadata 804), and then serially proceed to update second copy 816 with the appropriate changes. Once complete, the sequence number of the second copy can be updated appropriately.

Alternating protocol 828 can be employed in connection with noncritical update 826 and can operation as follows. In this example, controller 802 can determine that first copy 814 is to be updated first. Again, such can be determined based on the sequence numbers. For instance, if the sequence numbers indicate that second copy 816 the newest version of metadata 804, then first copy 814 (e.g., the oldest version) can be selected. Controller 802 can update first copy 814 with the appropriate changes (e.g., in a manner the same or similar to the update of metadata 804 in second memory 902). Then, controller 802 update the sequence number of first copy 814 (e.g., to reflect that first copy 814 is now the newest version of metadata 804). It is understood that in accordance with alternating protocol 828, only one of the two copies 814 and 816 need be updated for each metadata change. Thus, wear can be reduced on TTM that are reserved for metadata partition 812.

It is moreover understood that due to advantages detailed herein in connection with various metadata 804, such can be implemented to trigger very infrequently in any event, which can further reduce wear and other overhead associated with managing metadata 804. For example, it is observed that updates due to SWL trigger very infrequently relative to other wear leveling systems.

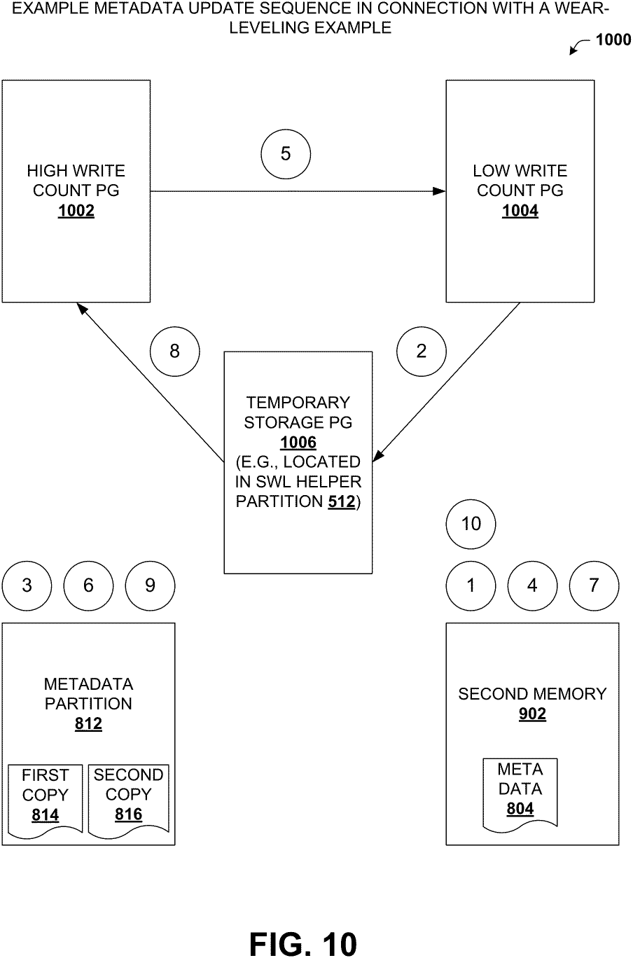

With reference now to FIG. 10, block diagram 1000 illustrates an example metadata update sequence in connection with a wear-leveling example in accordance with certain embodiments of this disclosure. In this embodiment, wear-leveling is deemed to be a critical update and hence, serial protocol 824 can be employed. However, such can In this example, data from a high write count PG 1002 is swapped with data from a low write count PG 1004. Such can employ a temporary storage PG 1006, which can in some embodiments physically reside in metadata partition 812 or in another reserved partition such as SWL helper partition 512, which can be substantially a single PG in size.

In that regard, at sequence 1, metadata 804 residing in second memory 902 can be updated to reflect that the low write count LG (associated with low write count PG 1004) points to temporary storage PG 1006. It is noted that at this point, the state of an associated memory device (e.g., memory device 800) is such that temporary storage PG 1006 does not yet store data associated with the low write count PG 1004, but metadata 804 (e.g., residing in volatile memory) can be updated in advance. It is understood that if a power loss occurs after sequence 1 has occurred, only the metadata in volatile memory is lost, and that metadata is not (yet) correct, so upon power on, the (still) correct metadata in metadata partition 812 can be loaded to volatile memory without any loss of information or continuity.

At sequence 2, data can be copied from low write count PG 1004 to temporary storage PG 1006. It is appreciated that at this point, information in metadata 804 is (now) correct by indicating the data in question (e.g., that of low write count PG 1004) is located at temporary storage PG 1006. However, it is also appreciated that information in metadata partition 812 is (still) also correct by indicating the data in question is at low write count PG 1004. At this point, the data in question happens to be in both places, since it was copied from one to the other. Hence, metadata in both the second memory 902 (e.g., volatile) and metadata partition 812 (non-volatile) are correct representations of the state of the memory device even though they are not the same in that for the data in question, metadata 804 points to temporary storage PG 1006, whereas first copy 814 and second copy 816 point to low write count PG 1004.

At sequence 3, metadata in metadata partition 812 (e.g., first copy 814 and/or second copy 816) can be updated to reflect the data in question is at temporary storage PG 1006. Hence, first copy 814 and/or second copy 816 will be substantially identical to metadata 804. It is understood that if serial protocol 824 is being followed, then both first copy 814 and second copy 816 will have been updated in series. On the other hand, in embodiments in which alternating protocol 828 is employed, only one or the other might be updated.

At sequence 4, metadata 804 can be updated to reflect that information stored at high write count PG 1002 points instead to temporary storage PG 1006. Such can allow a write to happen for both PGs. At sequence 5, data from high write count PG 1002 is copied to low write count PG 1004. At sequence 6, metadata in metadata partition 812 (e.g., first copy 814 and/or second copy 816) can be updated to reflect the data in question resides at low write count PG 1004 instead of high write count PG 1002.

At sequence 7, metadata 804 can be updated to reflect the data in question resides at low write count PG 1004 instead of high write count PG 1002, after sequence 6 is complete. At sequence 8, data stored in temporary storage PG 1006 (which was originally stored at low write count PG 1004) is copied to high write count PG 1002. At sequence 9, metadata stored in metadata partition 812 can be updated to reflect the low write count data resides at high write count PG 1002. At sequence 10, the same can be updated to metadata 804. The data swap is complete.

The diagrams included herein are described with respect to interaction between several components of a memory device or an integrated circuit device, or memory architectures comprising one or more memory devices or integrated circuit devices. It should be appreciated that such diagrams can include those components, devices and architectures specified therein, some of the specified components / devices, or additional components / devices. Sub-components can also be implemented as electrically connected to other sub-components rather than included within a parent device. Additionally, it is noted that one or more disclosed processes can be combined into a single process providing aggregate functionality. For instance, a deposition process can comprise an etching process, or vice versa, to facilitate depositing and etching a component of an integrated circuit device by way of a single process. Components of the disclosed architectures can also interact with one or more other components not specifically described herein but known by those of skill in the art.

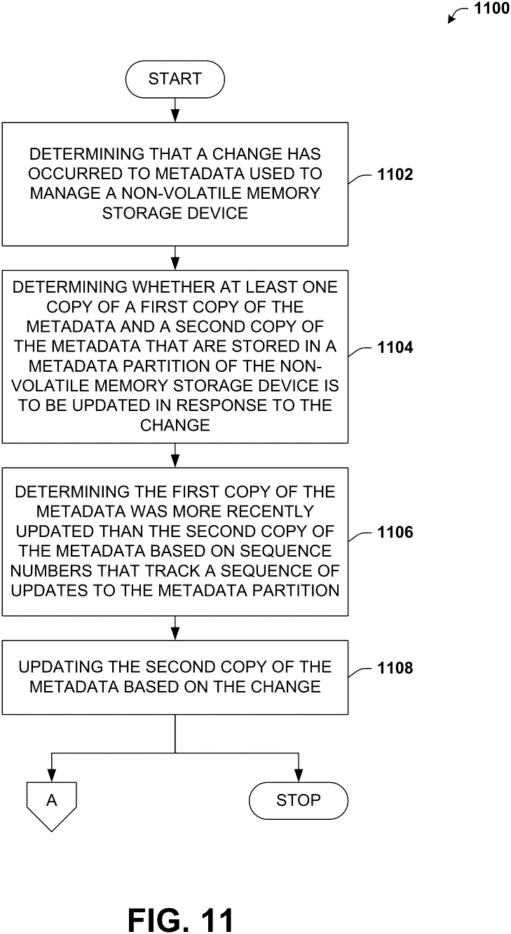

In view of the exemplary diagrams described supra, process methods that can be implemented in accordance with the disclosed subject matter will be better appreciated with reference to the flow charts of FIGS. 11-14. While for purposes of simplicity of explanation, the methods of FIGS. 11-14 are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. Additionally, it should be further appreciated that the methods disclosed throughout this specification are capable of being stored on an article of manufacture to facilitate transporting and transferring such methodologies to an electronic device. The term article of manufacture, as used, is intended to encompass a computer program accessible from any computer-readable device, device in conjunction with a carrier, or storage medium.

Turning now to FIG. 11, method 1100 is illustrated. Method 1100 provides an example procedure or method of managing metadata in accordance with certain embodiments of this disclosure. In some embodiments, method 1100 can provide for managing metadata in a manner that does not rely on or require additional or stored power sources such as super capacitors or batteries. At reference numeral 1102, a controller (e.g., controller 802) of a non-volatile memory storage device (e.g., memory device 800) comprising TTM (e.g., first memory 808) can determine that a change has occurred to metadata used to manage the non-volatile memory storage device. A common example of a change that can occur to metadata can be, e.g., changes to an L2P table due to wear leveling or other memory management operations or procedures.

At reference numeral 1104, the controller can determine whether at least one copy of the metadata that is stored in a metadata partition of the non-volatile memory storage device is to be updated in response to the change. For example, the controller can determine that one or more of multiple copies of the metadata are to be updated, such as an update to a first copy and/or a second copy of the metadata.

At reference numeral 1106, in response to a determination that the at least one copy is to be updated, the controller can determine the first copy of the metadata was more recently updated than the second copy of the metadata. In some embodiments, such a determination can be based on sequence numbers that track a sequence of updates to the metadata partition. In other words, if the first copy is the newer of the two copies and the second copy is the older of the two copies, then the second copy (e.g., the older of the two) can be selected to be updated and/or selected to be updated first (e.g., updated before the first copy is updated).

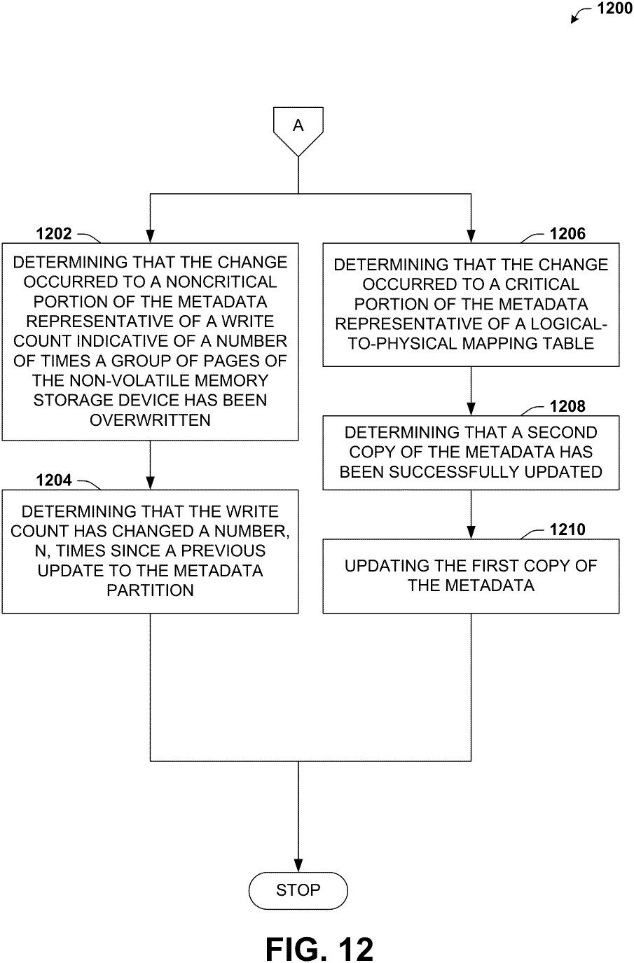

At reference numeral 1108, the controller can update the second copy of the metadata based on the change that was determined to have occurred at reference numeral 1102. Method 1100 can end or proceed to tab A, which is further detailed in connection with FIG. 12.

Referring now to FIG. 12, method 1200 is depicted. Method 1200 can provide for additional aspects or elements in connection with managing metadata in accordance with certain embodiments of this disclosure. For example, depending on the type of change to the metadata that has occurred at reference numeral 1102 of FIG. 11, the controller can determine various other elements. For instance, the controller can examine the change to the metadata and determine whether one or more of the copies of metadata (e.g., stored in non-volatile memory) is to be updated (e.g., see reference numeral 1104). As another example, based on examining the change to the metadata, the controller can determine whether more than one copy of the metadata is to be updated. Both such determinations can rely on a determination as to whether the change to the metadata represents a critical change to the metadata or a noncritical change to the metadata.

Thus, at reference numeral 1202, the controller can determine that the change occurred to a noncritical portion of the metadata. An example of a noncritical portion of the metadata can be, e.g., a write count indicative of a number of times a group of pages of the non-volatile memory storage device has been overwritten. At reference numeral 1204, the controller can determine that the at least one copy of the metadata is to be updated in response to a determination that the write count has changed a number, N, times since a previous update to the metadata partition. On the other hand, if the write count has changed fewer than N times, then the controller may determine (e.g., at reference numeral 1104) that no copy of the metadata need by updated in response to the change. It is understood that method 1200 can proceed to reference numerals 1202 and 1204 in cases where the change to the metadata was to a noncritical portion of the metadata.

On the other hand, method 1200 can proceed to reference numeral 1206. At reference numeral 1206, the controller can determine that the change occurred to a critical portion of the metadata. One example of a change to a critical portion of the metadata can be a change to a logical-to-physical mapping table. In such cases, the controller can determine in the affirmative that a copy of the metadata is to be updated and further that multiple copies of the metadata are to be updated as opposed to a single copy that can be updated in response to noncritical changes.

At reference numeral 1208, the controller can that the second copy of the metadata has been successfully updated (e.g., in connection with reference numeral 1108). Then, at reference numeral 1210, the controller can update the first copy of the metadata in addition to updating the second copy at reference numeral 1108. It is appreciated that in some embodiments, the controller can also increment or otherwise update sequence numbers for both the first copy and the second copy upon respective updates to either one. Method 1200 can end.

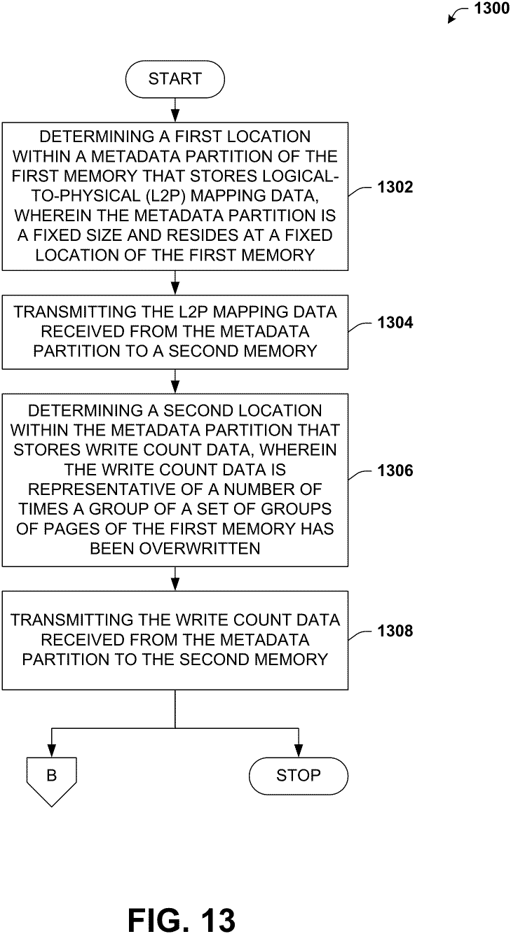

Turning now to FIG. 13, method 1300 is illustrated. Method 1300 provides an example procedure or method of loading the metadata to a second memory upon power on in accordance with certain embodiments of this disclosure. At reference numeral 1302, a controller of a first memory comprising non-volatile TTM can determine that a first location within a metadata partition of the first memory that stores L2P mapping data. The metadata partition can be a fixed or predetermined size and can begin or otherwise reside at fixed or predetermined location of the first memory. Appreciably, having a fixed location (and fixed size) can obviate the need for a discovery procedure that might lengthen the time required for the memory device to initialize or be responsive to commands.

At reference numeral 1304, the controller can transmit the L2P mapping data received from the metadata partition (e.g., beginning at the fixed location and potentially ending at another fixed location) to the second memory. In some embodiments, the second memory can be a volatile storage memory. Upon completion, it is understood that the second memory comprises at least the L2P mapping portion of the metadata. Thus, read and write operations (e.g., provided by a host device) can potentially be served, even before the entirety of the metadata has been reconstructed at the second memory.

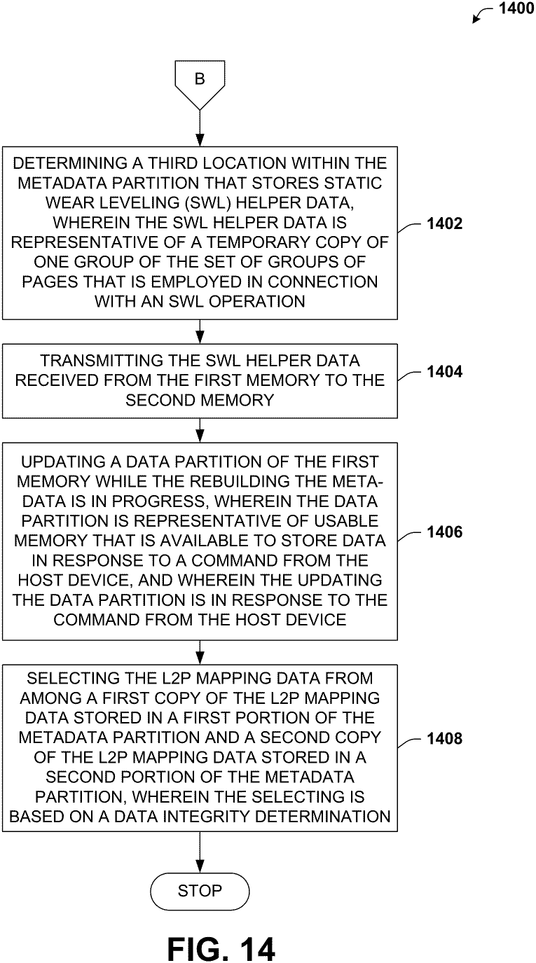

At reference numeral 1306, the controller can determine a second location within the metadata partition that stores write count data. The write count data can be representative of a number of times a group of a set of groups of pages of the first memory has been overwritten. As with the L2P mapping data, the write count data can be of a fixed size and reside at a fixed location. At reference numeral 1308, the controller can transmit the write count data received from the metadata partition to the second memory. Method 1300 can end or proceed to tab B, which is further detailed in connection with FIG. 14.

With reference now to FIG. 14, method 1400 is depicted. Method 1400 can provide for additional aspects or elements in connection with loading the metadata to the second memory upon power on in accordance with certain embodiments of this disclosure. For example, reference numeral 1402, the controller can determine a third location within the metadata partition that stores static wear leveling (SWL) helper data. The SWL helper data can be representative of a temporary copy of one group of the set of groups of pages that is employed in connection with an SWL operation. For example, the SWL helper data can be stored at a separate partition or within the metadata partition, but in either case, such can be at a fixed location and of a fixed size, e.g. about the size of a PG.

At reference numeral 1404, the controller can transmit the SWL helper data received from the first memory to the second memory. At this point, the entirety of the metadata has been reloaded to the second memory in some embodiments. However, as noted above, potentially during or after completion of rebuilding the L2P mapping data, the first memory can serve access commands, which can represent extremely rapid availability, very nearly instantaneous with power on in some cases. An example of such is provided in connection with reference numerals 1406.

At reference numeral 1406, the controller can update a data partition of the first memory while the reloading the metadata is in progress. The data partition can representative of usable memory that is available to store data in response to a command from the host device. In other words, the data access commands that reference information stored to the data partition can be served. Such updating the data partition can be in response to the command from the host device.

At reference numeral 1408, the controller can select the L2P mapping data from among a first copy of the L2P mapping data stored in a first portion of the metadata partition and a second copy of the L2P mapping data stored in a second portion of the metadata partition. In some embodiments, the selection between the first copy and the second copy can be determined based on a data integrity determination. The data integrity determination can be based on sequence numbers associated with the first copy and the second copy. In some embodiments, the data integrity determination can be based on a number of errors extant in the L2P mapping data in connection with the first copy and the second copy.

### Example Operating Environments

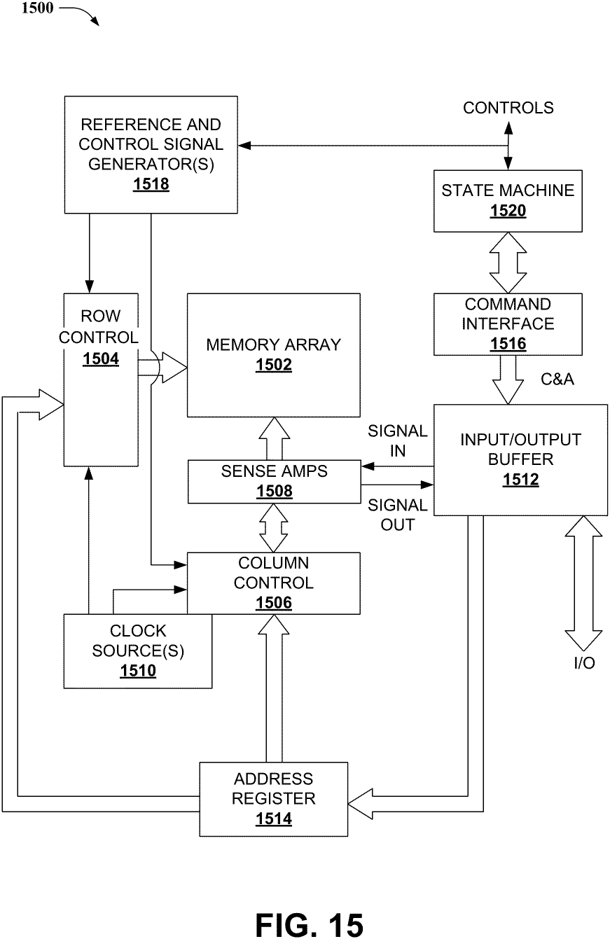

FIG. 15 illustrates a block diagram of an example operating and control environment 1500 for a memory array 1502 of a memory cell array according to aspects of the subject disclosure. In at least one aspect of the subject disclosure, memory array 1502 can comprise memory selected from a variety of memory cell technologies. In at least one embodiment, memory array 1502 can comprise a two-terminal memory technology, arranged in a compact two or three dimensional architecture. Suitable two-terminal memory technologies can include resistive-switching memory, conductive-bridging memory, phase-change memory, organic memory, magneto-resistive memory, or the like, or a suitable combination of the foregoing.

A column controller 1506 and sense amps 1508 can be formed adjacent to memory array 1502. Moreover, column controller 1506 can be configured to activate (or identify for activation) a subset of bit lines of memory array 1502. Column controller 1506 can utilize a control signal provided by a reference and control signal generator(s) 1518 to activate, as well as operate upon, respective ones of the subset of bitlines, applying suitable program, erase or read voltages to those bitlines. Non-activated bitlines can be kept at an inhibit voltage (also applied by reference and control signal generator(s) 1518), to mitigate or avoid bit-disturb effects on these non-activated bitlines.

In addition, operating and control environment 1500 can comprise a row controller 1504. Row controller 1504 can be formed adjacent to and electrically connected with word lines of memory array 1502. Also utilizing control signals of reference and control signal generator(s) 1518, row controller 1504 can select particular rows of memory cells with a suitable selection voltage. Moreover, row controller 1504 can facilitate program, erase or read operations by applying suitable voltages at selected word lines.

Sense amps 1508 can read data from, or write data to the activated memory cells of memory array 1502, which are selected by column control 1506 and row control 1504. Data read out from memory array 1502 can be provided to an input/output buffer 1512. Likewise, data to be written to memory array 1502 can be received from the input/output buffer 1512 and written to the activated memory cells of memory array 1502.

A clock source(s) 1508 can provide respective clock pulses to facilitate timing for read, write, and program operations of row controller 1504 and column controller 1506. Clock source(s) 1508 can further facilitate selection of word lines or bit lines in response to external or internal commands received by operating and control environment 1500. Input/output buffer 1512 can comprise a command and address input, as well as a bidirectional data input and output. Instructions are provided over the command and address input, and the data to be written to memory array 1502 as well as data read from memory array 1502 is conveyed on the bidirectional data input and output, facilitating connection to an external host apparatus, such as a computer or other processing device (not depicted, but see e.g., computer 1002 of FIG. 10, infra).

Input/output buffer 1512 can be configured to receive write data, receive an erase instruction, receive a status or maintenance instruction, output readout data, output status information, and receive address data and command data, as well as address data for respective instructions. Address data can be transferred to row controller 1504 and column controller 1506 by an address register 1510. In addition, input data is transmitted to memory array 1502 via signal input lines between sense amps 1508 and input/output buffer 1512, and output data is received from memory array 1502 via signal output lines from sense amps 1508 to input/output buffer 1512. Input data can be received from the host apparatus, and output data can be delivered to the host apparatus via the I/O bus.

Commands received from the host apparatus can be provided to a command interface 1516. Command interface 1516 can be configured to receive external control signals from the host apparatus, and determine whether data input to the input/output buffer 1612 is write data, a command, or an address. Input commands can be transferred to a state machine 1520.

State machine 1520 can be configured to manage programming and reprogramming of memory array 1502 (as well as other memory banks of a multi-bank memory array). Instructions provided to state machine 1520 are implemented according to control logic configurations, enabling state machine to manage read, write, erase, data input, data output, and other functionality associated with memory cell array 1502. In some aspects, state machine 1520 can send and receive acknowledgments and negative acknowledgments regarding successful receipt or execution of various commands. In further embodiments, state machine 1520 can decode and implement status-related commands, decode and implement configuration commands, and so on.

To implement read, write, erase, input, output, etc., functionality, state machine 1520 can control clock source(s) 1508 or reference and control signal generator(s) 1518. Control of clock source(s) 1508 can cause output pulses configured to facilitate row controller 1504 and column controller 1506 implementing the particular functionality. Output pulses can be transferred to selected bit lines by column controller 1506, for instance, or word lines by row controller 1504, for instance.

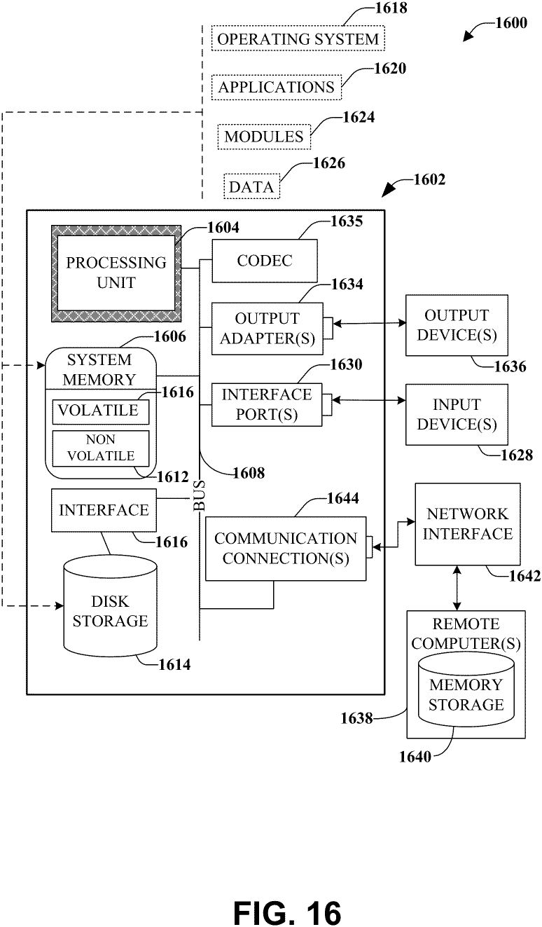

In connection with FIG. 16, the systems, devices, and/or processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated herein.

With reference to FIG. 16, a suitable environment 1600 for implementing various aspects of the claimed subject matter includes a computer 1602. The computer 1602 includes a processing unit 1604, a system memory 1606, a codec 1635, and a system bus 1608. The system bus 1608 couples system components including, but not limited to, the system memory 1606 to the processing unit 1604. The processing unit 1604 can be any of various available processors. Dual microprocessors and other multiprocessor architectures also can be employed as the processing unit 1604.

The system bus 1608 can be any of several types of bus structure(s) including the memory bus or memory controller, a peripheral bus or external bus, or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1606 includes volatile memory 1610 and non-volatile memory 1612, which can employ one or more of the disclosed memory architectures, in various embodiments. The basic input/output system (BIOS), containing the basic routines to transfer information between elements within the computer 1602, such as during start-up, is stored in non-volatile memory 1612. In addition, according to present innovations, codec 1635 may include at least one of an encoder or decoder, wherein the at least one of an encoder or decoder may consist of hardware, software, or a combination of hardware and software. Although, codec 1635 is depicted as a separate component, codec 1635 may be contained within non-volatile memory 1612. By way of illustration, and not limitation, non-volatile memory 1612 can include read only memory (ROM), programmable ROM (PROM), electrically programmable ROM (EPROM), electrically erasable programmable ROM (EEPROM), or Flash memory. Non-volatile memory 1612 can employ one or more of the disclosed memory devices, in at least some embodiments. Moreover, non-volatile memory 1612 can be computer memory (e.g., physically integrated with computer 1602 or a mainboard thereof), or removable memory. Examples of suitable removable memory with which disclosed embodiments can be implemented can include a secure digital (SD) card, a compact Flash (CF) card, a universal serial bus (USB) memory stick, or the like. Volatile memory 1610 includes random access memory (RAM), which acts as external cache memory, and can also employ one or more disclosed memory devices in various embodiments. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM) and so forth.

Computer 1602 may also include removable/non-removable, volatile/non-volatile computer storage medium. FIG. 16 illustrates, for example, disk storage 1614. Disk storage 1614 includes, but is not limited to, devices like a magnetic disk drive, solid state disk (SSD) floppy disk drive, tape drive, Jaz drive, Zip drive, LS-100 drive, flash memory card, or memory stick. In addition, disk storage 1614 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1614 to the system bus 1608, a removable or non-removable interface is typically used, such as interface 1616. It is appreciated that storage devices 1614 can store information related to a user. Such information might be stored at or provided to a server or to an application running on a user device. In one embodiment, the user can be notified (e.g., by way of output device(s) 1636) of the types of information that are stored to disk storage 1614 or transmitted to the server or application. The user can be provided the opportunity to opt-in or opt-out of having such information collected or shared with the server or application (e.g., by way of input from input device(s) 1628).

It is to be appreciated that FIG. 16 describes software that acts as an intermediary between users and the basic computer resources described in the suitable operating environment 1600. Such software includes an operating system 1618. Operating system 1618, which can be stored on disk storage 1614, acts to control and allocate resources of the computer system 1602. Applications 1620 take advantage of the management of resources by operating system 1618 through program modules 1624, and program data 1626, such as the boot/shutdown transaction table and the like, stored either in system memory 1606 or on disk storage 1614. It is to be appreciated that the claimed subject matter can be implemented with various operating systems or combinations of operating systems.

A user enters commands or information into the computer 1602 through input device(s) 1628. Input devices 1628 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1604 through the system bus 1608 via interface port(s) 1630. Interface port(s) 1630 include, for example, a serial port, a parallel port, a game port, and a universal serial bus (USB). Output device(s) 1636 use some of the same type of ports as input device(s) 1628. Thus, for example, a USB port may be used to provide input to computer 1602 and to output information from computer 1602 to an output device 1636. Output adapter 1634 is provided to illustrate that there are some output devices 1636 like monitors, speakers, and printers, among other output devices 1636, which require special adapters. The output adapters 1634 include, by way of illustration and not limitation, video and sound cards that provide a means of connection between the output device 1636 and the system bus 1608. It should be noted that other devices or systems of devices provide both input and output capabilities such as remote computer(s) 1638.

Computer 1602 can operate in a networked environment using logical connections to one or more remote computers, such as remote computer(s) 1638. The remote computer(s) 1638 can be a personal computer, a server, a router, a network PC, a workstation, a microprocessor based appliance, a peer device, a smart phone, a tablet, or other network node, and typically includes many of the elements described relative to computer 1602. For purposes of brevity, only a memory storage device 1640 is illustrated with remote computer(s) 1638. Remote computer(s) 1638 is logically connected to computer 1602 through a network interface 1642 and then connected via communication connection(s) 1644. Network interface 1642 encompasses wire or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1644 refers to the hardware/software employed to connect the network interface 1642 to the bus 1608. While communication connection 1644 is shown for illustrative clarity inside computer 1602, it can also be external to computer 1602. The hardware/software necessary for connection to the network interface 1642 includes, for exemplary purposes only, internal and external technologies such as, modems including regular telephone grade modems, cable modems and DSL modems, ISDN adapters, and wired and wireless Ethernet cards, hubs, and routers.

As utilized herein, terms “component,” “system,” “architecture” and the like are intended to refer to a computer or electronic-related entity, either hardware, a combination of hardware and software, software (e.g., in execution), or firmware. For example, a component can be one or more transistors, a memory cell, an arrangement of transistors or memory cells, a gate array, a programmable gate array, an application specific integrated circuit, a controller, a processor, a process running on the processor, an object, executable, program or application accessing or interfacing with semiconductor memory, a computer, or the like, or a suitable combination thereof. The component can include erasable programming (e.g., process instructions at least in part stored in erasable memory) or hard programming (e.g., process instructions burned into non-erasable memory at manufacture).

By way of illustration, both a process executed from memory and the processor can be a component. As another example, an architecture can include an arrangement of electronic hardware (e.g., parallel or serial transistors), processing instructions and a processor, which implement the processing instructions in a manner suitable to the arrangement of electronic hardware. In addition, an architecture can include a single component (e.g., a transistor, a gate array, ...) or an arrangement of components (e.g., a series or parallel arrangement of transistors, a gate array connected with program circuitry, power leads, electrical ground, input signal lines and output signal lines, and so on). A system can include one or more components as well as one or more architectures. One example system can include a switching block architecture comprising crossed input/output lines and pass gate transistors, as well as power source(s), signal generator(s), communication bus(ses), controllers, I/O interface, address registers, and so on. It is to be appreciated that some overlap in definitions is anticipated, and an architecture or a system can be a stand-alone component, or a component of another architecture, system, etc.

In addition to the foregoing, the disclosed subject matter can be implemented as a method, apparatus, or article of manufacture using typical manufacturing, programming or engineering techniques to produce hardware, firmware, software, or any suitable combination thereof to control an electronic device to implement the disclosed subject matter. The terms “apparatus” and “article of manufacture” where used herein are intended to encompass an electronic device, a semiconductor device, a computer, or a computer program accessible from any computer-readable device, carrier, or media. Computer-readable media can include hardware media, or software media. In addition, the media can include non-transitory media, or transport media. In one example, non-transitory media can include computer readable hardware media. Specific examples of computer readable hardware media can include but are not limited to magnetic storage devices (e.g., hard disk, floppy disk, magnetic strips...), optical disks (e.g., compact disk (CD), digital versatile disk (DVD)...), smart cards, and flash memory devices (e.g., card, stick, key drive...). Computer-readable transport media can include carrier waves, or the like. Of course, those skilled in the art will recognize many modifications can be made to this configuration without departing from the scope or spirit of the disclosed subject matter.

What has been described above includes examples of the subject innovation. It is, of course, not possible to describe every conceivable combination of components or methodologies for purposes of describing the subject innovation, but one of ordinary skill in the art can recognize that many further combinations and permutations of the subject innovation are possible. Accordingly, the disclosed subject matter is intended to embrace all such alterations, modifications and variations that fall within the spirit and scope of the disclosure. Furthermore, to the extent that a term “includes”, “including”, “has” or “having” and variants thereof is used in either the detailed description or the claims, such term is intended to be inclusive in a manner similar to the term “comprising” as “comprising” is interpreted when employed as a transitional word in a claim.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Additionally, some portions of the detailed description have been presented in terms of algorithms or process operations on data bits within electronic memory. These process descriptions or representations are mechanisms employed by those cognizant in the art to effectively convey the substance of their work to others equally skilled. A process is here, generally, conceived to be a self-consistent sequence of acts leading to a desired result. The acts are those requiring physical manipulations of physical quantities. Typically, though not necessarily, these quantities take the form of electrical or magnetic signals capable of being stored, transferred, combined, compared, and/or otherwise manipulated.

It has proven convenient, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise or apparent from the foregoing discussion, it is appreciated that throughout the disclosed subject matter, discussions utilizing terms such as processing, computing, replicating, mimicking, determining, or transmitting, and the like, refer to the action and processes of processing systems, and/or similar consumer or industrial electronic devices or machines, that manipulate or transform data or signals represented as physical (electrical or electronic) quantities within the circuits, registers or memories of the electronic device(s), into other data or signals similarly represented as physical quantities within the machine or computer system memories or registers or other such information storage, transmission and/or display devices.

In regard to the various functions performed by the above described components, architectures, circuits, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In addition, while a particular feature may have been disclosed with respect to only one of several implementations, such feature may be combined with one or more other features of the other implementations as may be desired and advantageous for any given or particular application. It will also be recognized that the embodiments include a system as well as a computer-readable medium having computer-executable instructions for performing the acts and/or events of the various processes.

What is claimed is:

1. A memory device, comprising:
a controller that manages metadata used to facilitate memory management procedures; and
a first memory operatively coupled to the controller, wherein the first memory comprise an array of non-volatile two-terminal memory cells, and
wherein the first memory comprises multiple partitions comprising:
a data partition representative of usable memory that is available to store host data provided by a host device; and
a metadata partition representative of non-usable memory that is not available to store the host data provided by the host device, wherein the metadata partition stores a first copy of the metadata and a second copy of the metadata.

2. The memory device of claim 1, wherein the metadata partition has a fixed size and has a fixed location within the first memory.

3. The memory device of claim 1, wherein the memory management procedures comprise a procedure selected from a group consisting essentially of: a logical-to-physical (L2P) mapping procedure, physical-to-logical (P2L) mapping procedure, a wear-leveling procedure, metadata handling procedure, and a power failure recovery or power on procedure.

4. The memory device of claim 1, wherein the metadata comprises first metadata selected from a group consisting essentially of: L2P mapping data, static wear leveling data, and write counter data.

5. The memory device of claim 1, wherein the data partition represents a storage area for data of high-level applications.

6. The memory device of claim 1, wherein the metadata partition comprises a first portion that is accessible via a first channel and a second portion that is equal in size to the first portion and that is accessible via a second channel different than the first channel, and wherein first portion comprises the first copy of the metadata and the second portion comprises the second copy of the metadata.

7. The memory device of claim 1, wherein the controller determines an update to the metadata stored in the metadata partition in response to determining the update is one of: a critical update and a noncritical update.

8. The memory device of claim 7, wherein in response to a determination that the update is the critical update, the controller updates the metadata according to a serial protocol characterized as updating the first copy of the metadata within the metadata partition, determining that the first copy of the metadata has been updated, and updating the second copy of the metadata within the metadata partition.

9. The memory device of claim 7, wherein in response to a determination that the update is the noncritical update, the controller updates the metadata according to an alternating protocol characterized as selecting an oldest version of the metadata from among the first copy of the metadata and the second copy of the metadata and updating the oldest version of the metadata.

10. The memory device of claim 7, wherein the metadata is further stored in a second memory comprising volatile memory cells and wherein the controller copies the metadata stored in the second memory to the metadata partition of the first memory in order to update the metadata within the metadata partition.

11. The memory device of claim 1, wherein the metadata partition is page-addressable, and wherein a size of the metadata partition is less than about one percent of a total capacity of the first memory.

12. A method of storing metadata, comprising:
determining, by a controller of a non-volatile memory storage device comprising two-terminal memory, that a change has occurred to metadata used to manage the non-volatile memory storage device;
determining, by the controller, whether at least one copy of a first copy of the metadata and a second copy of the metadata that are stored in a metadata partition of the non-volatile memory storage device is to be updated in response to the change;
in response to a determination that the at least one copy is to be updated, determining the first copy of the metadata was more recently updated than the second copy of the metadata based on sequence numbers that track a sequence of updates to the metadata partition; and
updating, by the controller, the second copy of the metadata based on the change.

13. The method of claim 12, wherein the determining whether the at least one copy of the metadata is to be updated comprises determining that the change occurred to a noncritical portion of the metadata representative of a write count indicative of a number of times a group of pages of the non-volatile memory storage device has been overwritten.

14. The method of claim 13, further comprising determining that the at least one copy of the metadata is to be updated in response to a determination that the write count has changed a number, N, times since a previous update to the metadata partition.

15. The method of claim 12, further comprising determining that the at least one copy of the metadata is to be updated in response to a determination that the change occurred to a critical portion of the metadata representative of a logical-to-physical mapping table.

16. The method of claim 15, further comprising:
determining that the second copy of the metadata has been successfully updated;
incrementing a sequence number of the second copy of the metadata; and
updating the first copy of the metadata.

17. A method of reloading metadata on power on, comprising:
determining, by a controller of a first memory comprising non-volatile two-terminal memory, a first location within a metadata partition of the first memory that stores logical-to-physical (L2P) mapping data, wherein the metadata partition is a fixed size and resides at a fixed location of the first memory;
transmitting, by the controller, the L2P mapping data received from the metadata partition to a second memory;
determining, by the controller, a second location within the metadata partition that stores write count data, wherein the write count data is representative of a number of times a group of a set of groups of pages of the first memory has been overwritten; and
transmitting, by the controller, the write count data received from the metadata partition to the second memory.

18. The method of claim 17, further comprising determining, by the controller, a third location within the metadata partition that stores static wear leveling (SWL) helper data, wherein the SWL helper data is representative of a temporary copy of one group of the set of groups of pages that is employed in connection with an SWL operation.

19. The method of claim 18, further comprising transmitting, by the controller, the SWL helper data received from the first memory to the second memory.

20. The method of claim 17, further comprising updating a data partition of the first memory while the reloading the metadata is in progress, wherein the data partition is representative of usable memory that is available to store data in response to a command from the host device, and wherein the updating the data partition is in response to the command from the host device.
